(19) United States
(12) Patent Application Publication
(10) Pub. No.: US 2022/0397995 A1
(43) Pub. Date: Dec. 15, 2022

(54) DASHBOARD EXPLORE MODE

(71) Applicant: Microsoft Technology Licensing, LLC, Redmond, WA (US)

(72) Inventors: Yash Misra, Kirkland, WA (US); Shengbo Xue, Kirkland, WA (US); Charlie Lertlumprasert, Minneapolis, MN (US); Dorothy Feng, Seattle, WA (US); Priya Chauhan, Duvall, WA (US); Hanna McLaughlin, Seattle, WA (US); Kiran Kumar, Redmond, WA (US); Lauren Edelmeier, Seattle, WA (US)

(21) Appl. No.: 17/360,627

(22) Filed: Jun. 28, 2021

Related U.S. Application Data
(63) Continuation-in-part of application No. 17/348,032, filed on Jun. 15, 2021.

(51) Int. Cl. G06F 3/0485; G06F 3/0482

(52) U.S. Cl. CPC G06F 3/0485; G06F 3/0482; G06F 2203/04803

(57) ABSTRACT

A dashboard panel application provides a content immersion experience. The dashboard panel application enables a user to scroll through headlines from multiple endpoints and delve deeper into a topic of interest while continuing to scroll the headlines from the same scrolling position. A first dashboard panel view including a first scrollable arrangement of content cards is caused to be rendered on a base graphical canvas. Each card is related to a respective content item. When a card is selected, the scroll state is stored, and the first dashboard panel view is dismissed. Additional content related to the selected card is displayed in a content immersion viewer pane. A second dashboard panel view comprising a second scrollable arrangement of the content cards is caused to be rendered with the content immersion viewer pane, and the scroll state is re-applied. The dashboard panel and content immersion viewer panes are independently scrollable.

### CROSS-REFERENCE TO RELATED APPLICATIONS

This application claims priority to pending U.S. patent application Ser. No. 17/348,032 (Attorney Docket No. 409833-US-NP) entitled “SERVICE-DRIVEN WIDGETS WITH MULTIPLE FORMS OF AUTHENTICATION DISPLAYED IN A WIDGETS BOARD,” which was filed on Jun. 15, 2021, and is incorporated by reference herein in its entirety.

### BACKGROUND

An application (an “app”) is program code that runs on the operating system of a computing device. An application is designed to carry out a specific task other than one relating to the operation of the computing device itself and is typically configured to be used by end-users. Examples of an application include a word processor, a spreadsheet program, an accounting application, an email client, a media player, a console game, and a photo editor. A computing device may have many applications installed, each of which uses a commensurate amount of storage. Furthermore, the features of an application are accessed by executing the application. Many applications simultaneously executing on a computing device consume a significant amount of memory and processing resources.

A web browser is a type of a type of application that enables web applications (“web apps”) to be run on a computing device. The web browser downloads content of a web application from a server to the computing device. The web browser renders a page of content related to the web application for display to the user. Multiple tabs may be maintained by the web browser, with each containing content related to a different web page, though typically with a single tab displayed to the user at any given time. A conventional web browser application may have additional features, including various navigation features. Such navigation features may include an address bar that receives a URL for navigation to a website specified by a uniform resource locator (URL), a search bar to input items for a search engine, and a book-marking bar that allows a user to save URLs for later use. On the other hand, a content viewer (e.g., web viewer) may be configured to render a web page that can be interacted with, but may not provide the features of a full browser application.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, apparatuses, and computer-readable storage media described herein provide a content immersion experience by facilitating continuity of a viewing context. For example, a dashboard panel application and an immersion experience manager enable a user to scroll through headlines received from multiple endpoints and delve deeper into a topic of interest while continuing to view the headlines from the same scrolling position, without the use of a conventional web browser.

In an aspect, an operating system (OS) is configured to render a base graphical canvas on a display screen. Program code executed by a processor circuit is configured to cause a first dashboard panel view to be rendered on the base graphical canvas that includes a first scrollable arrangement of content cards. Each content card comprises information related to a respective content item. In response to receiving a selection of a first content card of the content cards, a first scroll state of the scrollable arrangement is stored. The first dashboard panel view is dismissed from display. Additional content of the respective content item associated with the selected first content card is displayed in a first content immersion viewer pane on the base graphical canvas. A second dashboard panel view is caused to be rendered on the base graphical canvas with the first content immersion viewer pane. The second dashboard panel view comprises a second scrollable arrangement of the content cards. The first scroll state is applied to the second dashboard panel view.

Further features and advantages of embodiments, as well as the structure and operation of various embodiments, are described in detail below with reference to the accompanying drawings. It is noted that the methods and systems are not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of a system for rendering a dashboard panel that includes multiple widgets accessed according to various account credentials, according to an example embodiment.

FIG. 2 shows a flowchart of a method in a computing device for rendering a dashboard panel that includes multiple widgets accessed according to various account credentials, according to an example embodiment.

FIG. 3 shows a block diagram of a dashboard panel application and associated data storage, according to an example embodiment.

FIG. 4 shows a block diagram of a widget manifest in accordance with an example embodiment.

FIG. 5 shows a display screen displaying a dashboard panel in accordance with an example embodiment.

FIG. 6 shows a display screen displaying a widget selector of a dashboard panel application in accordance with an example embodiment.

FIG. 7 shows a flowchart of a method of selection of a widget for inclusion in a dashboard panel, according to an example embodiment.

FIG. 8 shows a flowchart of a method of rendering and customizing widgets in a dashboard panel in accordance with an example embodiment.

FIG. 9 shows a flowchart of a method of displaying web content with respect to a widget in a dashboard panel in accordance with an example embodiment.

FIG. 10 shows a block diagram of a system for rendering a dashboard that includes scrollable content cards and a content immersion pane, according to an example embodiment.

FIG. 11 shows a flowchart of a method in a computing device for rendering a flow of dashboard panel views in an immersion experience comprising scrollable content cards and a selectable expanded view, according to an example embodiment.

FIG. 12 shows a block diagram of a system for rendering a flow of dashboard panel views in an immersion experience comprising scrollable content cards and a selectable expanded view, according to an example embodiment.

FIGS. 13-15 illustrate example displays of scrollable arrangements of content cards prior to entering an immersion experience view, according to example embodiments.

FIG. 16 comprises a display that illustrates an example content immersion experience display comprising a second dashboard panel view that includes a second scrollable arrangement of content cards and a first content immersion viewer pane, according to an example embodiment.

FIG. 17 shows a flowchart of a method for responding to a second selection of a content card in a second scrollable arrangement while a first content immersion pane is being displayed, according to an example embodiment.

FIG. 18 shows a flowchart of a method for responding to a user interaction with a navigation link in a first content immersion pane, according to an example embodiment.

FIG. 19 shows a block diagram of an exemplary user device in which embodiments may be implemented.

FIG. 20 shows a block diagram of an example processor-based computer system that may be used to implement various embodiments.

The features and advantages of the embodiments described herein will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

II. Service-Driven Widgets with Multiple Forms of Authentication Displayed in a Widget Board

Embodiments disclosed herein enable a dashboard panel application to make available “widgets” to a user on a computing device, which provide functionality for multiple applications simultaneously without corresponding applications having to be installed or running (if installed) on the computing device, and without the use of a conventional web browser. Conventionally, to access the functionality of applications, the applications must either be installed directly on the computing device or operated as web applications in a web browser. In the case of applications directly installed on the computing device, significant storage space may be used, including long term storage (e.g., disk space) and memory, as well as significant processing bandwidth being consumed. In the case of web applications, a web browser must be installed on the computing device being used, with its commensurate storage space and processing bandwidth requirements. In contrast, in embodiments of the present techniques, a single dashboard panel application is executed that manages multiple widgets having respective application functionality, while requiring substantially less storage space and processing bandwidth to operate.

A widget is a graphical user interface (GUI)-accessible view of an application that provides functionality of the application at a computing device without code of the application being executed on the computing device. Rather, a widget host application, primarily referred to herein as dashboard panel application, enables application functionality for a widget based on a widget manifest associated with the widget, and upon service data received from a network-based service associated with the widget and application.

As such, in embodiments, the widgets are services driven. Rather than requiring an application to be installed in the computing device in order to build a widget in a conventional manner, the present techniques leverage a remote service to supply data to a widget according to the manifest associated with the widget. The supplied data is used to fill in fields of the widget when rendered for display.

Still further, in embodiments, the computing device is configured to provide authentication with multi-account support. Widgets accessed with different user sign-in credentials can be displayed in a same dashboard panel pane simultaneously (e.g., side-by-side). The dashboard panel application may automatically make a user account associated with an operating system (OS) available to widgets. The dashboard panel application may further enable the user to provide user credentials for third-party accounts on a widget-by-widget basis, such as at the time of widget configuration.

In turn, the computing device (“client”) sends the user account information to the services associated with the widgets to authenticate the user accounts and retrieve service data, which is then caused to be rendered in the dashboard panel for the user. In this manner, multiple user accounts may be used in a common dashboard panel application to display information of interest to the user. Widgets can access data at a variety of services, and in an embodiment, a widget may be interacted with (e.g., clicked upon or engaged via a user voice command) in a displayed dashboard panel to launch the corresponding application on the computing device (if installed there), in order to provide the full application functionality. In an embodiment, if the corresponding application is not installed on the computing device at a time the application is launched from the widget, the computing device may display a prompt to install the application to the user.

As described below, in addition to displaying widgets, in some embodiments, the dashboard panel application may be configured to display content from other sources, such as a content feeds service (e.g., a news feeds service). For example, the dashboard panel application may display content cards comprising headlines from online news articles, highlights from various webpages, weather data from a weather application, sports data, financial data, blog posts, etc.

It is noted that while embodiments may be described herein with reference to uniform resource locators (URLs), such embodiments are applicable to any type of uniform resource indicator (URI), including, but not limited to URLs, uniform resource names (URNs), etc. Embodiments for a dashboard panel may be implemented and may operate in various ways. Such embodiments are described as follows.

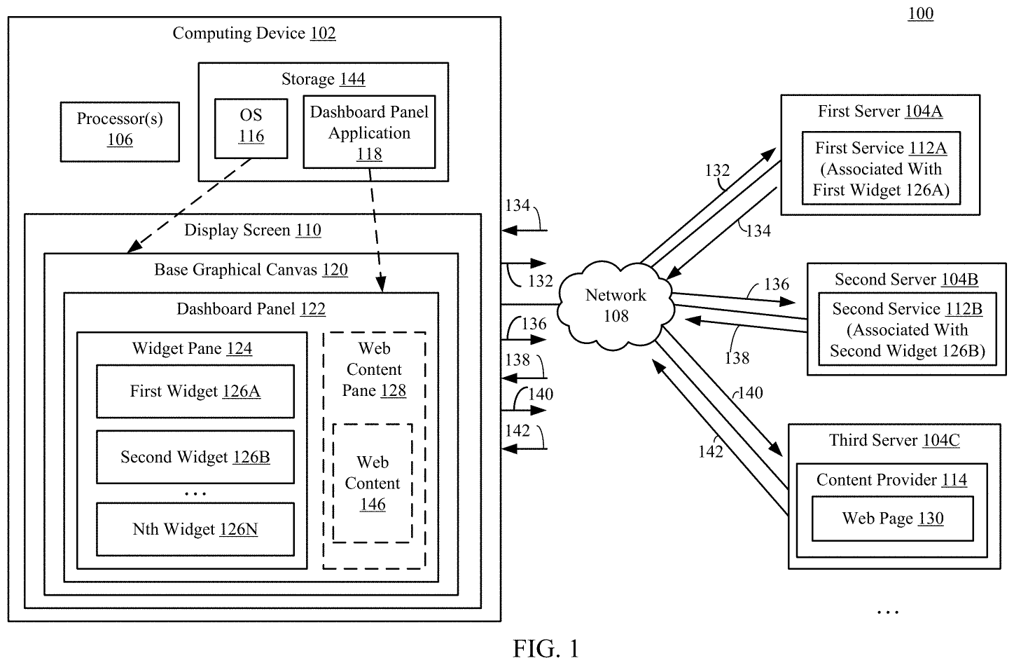

For instance, FIG. 1 shows a block diagram of a system 100 for rendering a dashboard panel that includes multiple widgets having various account credentials, according to an example embodiment. As shown in FIG. 1, system 100 includes a computing device 102, a first server 104A, a second server 104B, and a third server 104C. Computing device 102 is communicatively coupled to first through third servers 104A-104C via a network 108. Computing device 102 includes one or more processors 106, storage 144, and a display screen 110. Storage 144 stores an OS 116 and a dashboard panel application 118. First server 104A hosts a first service 112A. Second server 104B hosts a second service 112B. Third server 104C hosts a content provider 114. These features of system 100 are described in further detail as follows.

Computing device 102 is a computing device via which a user is enabled to run applications and visit web pages. Computing device 102 may be any type of mobile computing device, such as a Microsoft® Surface® device, a personal digital assistant (PDA), a laptop computer, a notebook computer, a tablet computer such as an Apple iPad™, a netbook, a smart phone (such as an Apple iPhone, a phone implementing the Google® Android™ operating system), a wearable computing device (e.g., a head-mounted device including smart glasses such as Google® Glass™, a virtual headset such as Oculus Rift® by Oculus VR, LLC or HoloLens® by Microsoft Corporation), a stationary computing device such as a desktop computer or PC (personal computer), or other browser-enabled device. Each of servers 104A-104C may be computing devices that are configured to manage services and/or host and serve web pages. For instance, as shown in FIG. 1, content provider 114 at third server 104C hosts one or more web pages (e.g., websites) such as a web page 130.

Network 108 may comprise one or more networks such as local area networks (LANs), wide area networks (WANs), enterprise networks, the Internet, etc., and may include one or more of wired and/or wireless portions.

Processor(s) 106 includes any number of processors, including central processing units (CPUs), microprocessors, multi-processors, processing cores, and/or any other hardware-based processor types described herein or otherwise known. Storage 144 may include one or more of any type of physical storage mechanism, including a magnetic disc (e.g., in a hard disk drive), an optical disc (e.g., in an optical disk drive), a solid-state drive (SSD), a memory device such as a RAM (random access memory) device, a ROM (read only memory) device, and/or any other suitable type of physical, hardware-based storage medium. OS 116 may be any suitable type of operating system, including Microsoft Windows®, Apple Mac OS® X, Google Android™, and Linux®. Display screen 110 is a display screen of any suitable type of display, which may be built into or physically separate from computing device 102, such as a cathode ray tube (CRT) display, a liquid crystal display (LCD) display, a light emitting diode (LED) display, a plasma display, or other display type. Note that display screen 110 may be a single display screen or may be comprised of multiple separate display screens. As shown in FIG. 1, OS 116 renders a base graphical canvas 120 (also be referred to as a “desktop background”) on display screen 110. Base graphical canvas 120 may show a background image or may be blank.

Dashboard panel application 118 is an application configured to enable users to select widgets from a variety of widgets for rendering in a dashboard panel managed by dashboard panel application 118. A widget is not an independent application but is generated by dashboard panel application 118 based on a widget-specific manifest, user customization data, and/or service data (content). A widget is associated with a service separate from the dashboard panel application from which the service data is retrieved. A widget is configured to display and provide interactive content associated with the service without providing the full functionality of a website or an application that may be associated with the service. By enabling a user to provide user customization data to configure the widgets, the dashboard panel application generates a dashboard panel as a convenient, unified solution for the user to peruse information associated each of with the services. The dashboard panel may be viewed by the user relatively quickly compared to the user individually executing and viewing multiple separate applications associated with the represented services, instead providing an aggregate overview of experiences and interests.

As shown in FIG. 1, dashboard panel application 118 causes a dashboard panel 122 to be rendered on base graphical canvas 120. Dashboard panel 122, which may also be referred to as a “widgets board,” is a displayed GUI window on which widgets are rendered. In the example of FIG. 1, dashboard panel 122 includes a widget pane 124, which includes first through nth widgets 126A-126N. Any number of widgets may be present. Widgets 126A-126N are widgets selected by the user and/or automatically selected, for inclusion in dashboard panel 122 and configurable by the user. In FIG. 1, widgets 126A-126N each display corresponding content, such as weather data in a weather widget, calendar information in a calendar widget, news data in a news widget, photos in a photo widget, movie icons in a streaming video widget, book review summaries in a bookstore widget, etc. Each widget may be associated with a corresponding service for retrieving content. Furthermore, widgets 126A-126N may include multiple instances of a same widget that a user selected to be displayed in dashboard panel 122 multiple times. For example, the user may desire to have multiple weather widgets displayed, a first weather widget instance configured to display weather for Seattle, Wash., and a second weather widget instance configured to display weather for New York City, N.Y.

As shown in FIG. 1, first widget 126A may be associated with first service 112A at server 104A, and second widget 126B may be associated with second service 112B at server 104B. Further widgets may be associated with any number of additional services not shown in FIG. 1. When dashboard panel 122 is to be rendered, a request related to first widget 126A may be transmitted from computing device 102 as a first service request 132, through network 108, to first service 112A at server 104A. First service request 132 may be a request for service data from first service 112A that may be displayed in a view frame (or “card”) of first widget 126A in dashboard panel 122. Any type of service data may be retrieved, including textual information, image files, audio files, video files, etc. In response to request 132, first service 112A generates a first widget service data signal 134 that is transmitted from first server 104A through network 108 to computing device 102. First widget service data signal 134 includes service data generated by first service 112A in response to first service request 132. Dashboard panel application 118 causes dashboard panel 122 to be rendered to include the service data of first widget service data signal 134 in the rendered view of first widget 126A. Similarly, a request related to second widget 126B may be transmitted from computing device 102 as a second service request 136, through network 108, to second service 112B at server 104B. Second service request 136 may be a request for service data from second service 112B that may be displayed in a view frame of second widget 126B in dashboard panel 122. In response to request 136, second service 112B generates second widget service data signal 138 that is transmitted from second server 104B through network 108 to computing device 102. Second widget service data signal 138 includes service data generated by second service 112B in response to second service request 136. Dashboard panel application 118 causes dashboard panel 122 to be rendered include the received service data of second widget data signal 138 in the rendered view of widget 126B.

Furthermore, in an embodiment, dashboard panel 122 may optionally include a web content pane 128, which includes a rendering of web content 146. For example, a user may interact with a link displayed in a news item of a news widget in widget pane 124. This may cause web content pane 128 to be rendered in dashboard panel 122 to display a news web page as web content 146. In another embodiment, web content pane 128 may alternatively be presented in a web browser.

For example, as shown in FIG. 1, in response to an interaction (by a user) with first widget 126A in dashboard panel 122, a content request 140 may be generated by dashboard panel application 118. Content request 140 may include a network address (e.g., a URL) for content hosted by content provider 114 at third server 104C. Content request 140 is transmitted by computing device 102 through network 108 to content provider 114. In response to content request 140, content provider 114 may retrieve a web page at the network address, thereby accessing web page 130. Web page 130 may be transmitted by third server 104C in a content response 142 through network 108 to computing device 102. Dashboard panel application 118 causes web page 130 to be rendered in web content pane 128 of dashboard panel 122 as web content 146. Alternatively or additionally, the web page 130 may be rendered outside the dashboard panel 122, such as in a web browser. In embodiments, if the user interacts with web content 146 (e.g., clicks on a URL displayed therein) displayed in web content pane 128 of dashboard panel 122, subsequent web content may be invoked and displayed inside or outside (e.g., via a web browser) of dashboard panel 122. In an embodiment, dashboard panel application 118 enables rendering of first content in web content pane 128, in response to a first content selection made by the user (a first-level selection) from widget pane 124, but further selections made by the user (subsequent level selections) in the rendered first content of web content pane 128 are handled by an application external to dashboard panel application 118 and dashboard panel 122 (e.g., by a web browser). Alternatively or additionally, when a user interacts with a widget of widgets 126A-126N, such as the widget header, an application associated with the widget may be invoked internal or external to dashboard panel application 118 and dashboard panel 122. For instance, if the user “clicks” in the header of a photos widget, a photos application may be invoked in computing device 102 to execute outside of dashboard panel 122 and independently of dashboard panel application 118.

In this manner, any number of widgets may be provided in dashboard panel 122 with their resultant displayed content and functionality. A user may select each of widgets 126A-126N for inclusion in dashboard panel 122, and may configure each widget, such as providing location information, preference information, profile information, etc., so that each widget is customized for the user. Any number of user accounts may be used to sign into the widgets and to authenticate the user with the corresponding services for widget data retrieval. Any number of different widgets may be included in dashboard panel 122, providing visibility and/or access to a corresponding number of services. Furthermore, a widget may be interacted with to cause a relevant web page to be displayed, and/or to invoke a corresponding application in computing device 102 inside or outside of dashboard panel 122.

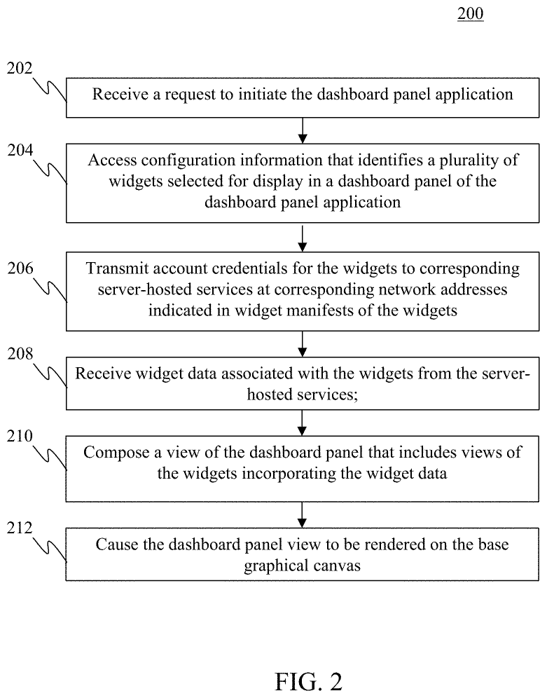

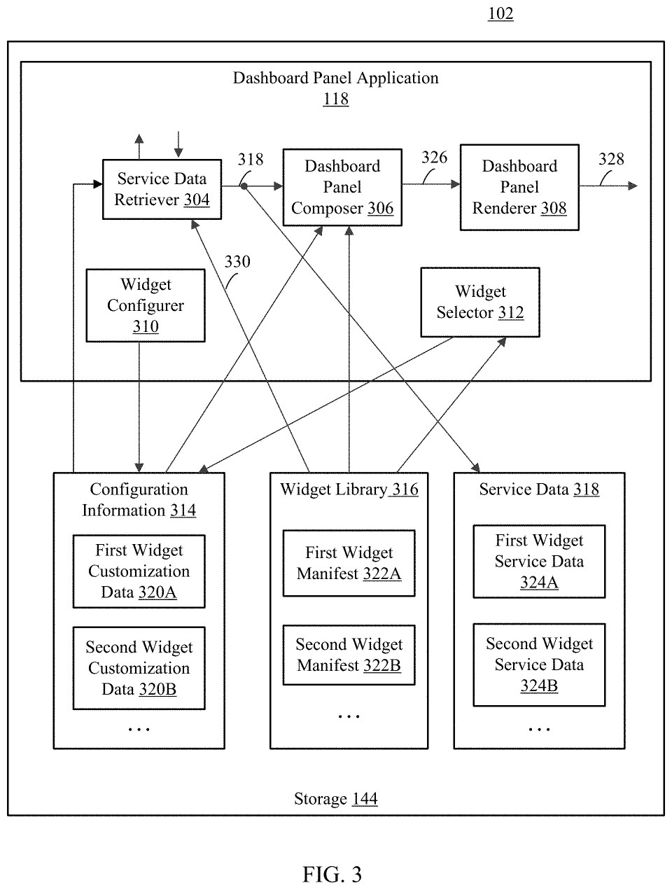

Note that dashboard panel application 118 of FIG. 1 may be configured in various ways, and may operate in various ways, to perform these and further functions. For instance, FIG. 2 shows a flowchart 200 of a method in a computing device for rendering a dashboard panel that includes multiple widgets with various account credentials, according to an example embodiment. Flowchart 200 may be implemented by dashboard panel application 118. For purposes of illustration, flowchart 200 is described with reference to FIG. 3. FIG. 3 shows a block diagram of contents of data storage 144, according to an example embodiment. As shown in FIG. 3, storage 114 stores dashboard panel application 118, configuration information 314, a widget library 316, and service data 318. Dashboard panel application 118 includes a service data retriever 304, a dashboard panel composer 306, a dashboard panel renderer 308, a widget configurer 310, and a widget selector (or “widget picker”) 312. Other structural and operational embodiments will be apparent to persons skilled in the relevant art(s) based on the following discussion regarding flowchart 200 and FIG. 3.

Flowchart 200 of FIG. 2 begins with step 202. In step 202, a request to initiate the dashboard panel application is received. In embodiments, dashboard panel application 118 may be requested to be initiated in various ways. For example, dashboard panel application 118 may be initiated by computing device 102 (FIG. 1) in response to a user interacting with a user interface (UI) control to input a request that dashboard panel application 118 be initiated. Examples of suitable UI controls include a taskbar button, a keyboard shortcut, a touch screen (e.g., a user swiping one or more fingers across display screen 110 (of FIG. 1), such as a swipe from the left edge), and a microphone and corresponding logic configured to receive and process a voice command. In another embodiment, dashboard panel application 118 may be requested to be initiated by being included in a startup routine for OS 116 (of FIG. 1), such that dashboard panel application 118 is invoked upon powering up computing device 102 or after a reboot. When dashboard panel application 118 initiates, an executable file of dashboard panel application 118 may be executed to launch the running of program code of dashboard panel application 118 by processor(s) 106. Upon launch, the user is logged into dashboard panel application 118. For example, dashboard panel application 118 may be configured to select an account from the account manager (e.g., Web Account Manager of Microsoft Corporation for Microsoft® Windows®, or alternative account manager for other operating system) of OS 116 (e.g., the user account logged into OS 116), or the user may be prompted to provide account credentials (login identifier and password).

In step 204, configuration information is accessed that identifies a plurality of widgets selected for display in a dashboard panel of the dashboard panel application, the plurality of widgets including a first widget and a second widget. In an embodiment, dashboard panel application 118 accesses configuration information 314 in storage 144 to configure dashboard panel 122 of FIG. 1. For instance, configuration information 314 may include user-configured information such as an indication of the widgets that the user selected for inclusion in dashboard panel 122, as well as configuration information supplied by the user for each of the indicated widgets. As shown in FIG. 3, configuration information 314 may include first widget customization data 320A, which includes user-specified customizations for first widget 126A (FIG. 1); second widget customization data 320B, which includes user-specified customizations for second widget 126B; and customization data for any further number of widgets. Examples of configuration information 314 defined for a widget include location information, profile information (such as the user's age, gender, etc.), preference information for each widget (e.g., a selected widget size, a color mode for a widget (e.g., color, light, dark, greyscale)), a type of widget selected from multiple types of the widget, etc. Configuration information 314 may be stored in a single file or multiple files (e.g., a file for each widget) of any suitable format, including text, XML (extensible markup language), binary, or other format.

Returning to FIG. 2, in step 206, account credentials for the widgets are transmitted to corresponding server-hosted services at corresponding network addresses indicated in widget manifests. In embodiments, each type of widget has an associated widget manifest that contains metadata regarding the widget type, and may contain assets for handling offline scenarios. For example, a widget manifest may include a network address that is an address of its associated service (located on one or more network accessible servers) with which the widget communicates for data. A widget manifest may exist for first widget 126A, for example, that includes a network address (e.g., a URL) for first service 112A at first server 104A. Furthermore, a widget manifest may exist for second widget 126B that includes a network address for second service 112B at second server 104B. Each unique type of widget may have a corresponding manifest that includes an associated network address, as well as further information for the particular widget type.

For instance, as shown in FIG. 3, a widget library 316 may be stored in storage 144. Widget library 316 includes a manifest for each unique widget that the user has selected for inclusion in dashboard panel 122 (FIG. 1), and in some embodiments, may include a manifest for each widget registered and available for user selection, whether or not selected for inclusion in dashboard panel 122. For example, as shown FIG. 3, widget library 316 includes a first widget manifest 322A for widget 126A (FIG. 1), a second widget manifest 322B for widget 126B, and widget manifests for any further number of available widgets. A widget manifest may be contained in a file of any suitable format, including a text file, a binary file, an XML file, a JSON (JavaScript Object Notation) file, or file of other format.

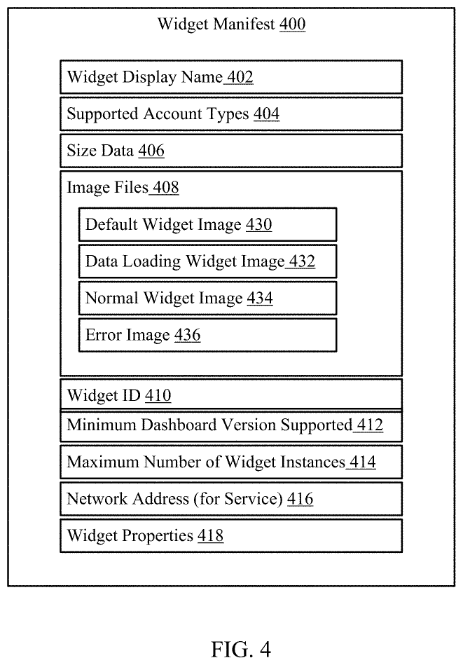

As mentioned, a widget manifest contains metadata regarding the corresponding widget type and may contain assets for handling offline scenarios. As such, a variety of types of data and/or metadata may be maintained for a widget in a widget manifest. For instance, FIG. 4 shows a block diagram of a widget manifest 400 in accordance with an example embodiment. Widget manifest 400 is an example of widget manifests 322A and 322B of FIG. 3. Any one or more of the metadata and/or data field parameters shown in widget manifest 400 may be included in a widget manifest, as well as further parameters that would be apparent to persons skilled in the relevant art(s) from the teachings herein.

In particular, as shown in FIG. 4, widget manifest 400 may include a widget display name 402, supported account types 404, size data 406, one or more image files 408, a widget ID (identifier) 410, a minimum dashboard version supported 412, a maximum number of widget instances 414, a network address for service 416, and one or more widget properties 418. Each of these fields of widget manifest 400 are described as follows.

Widget display name 402 is a name and/or title of the corresponding widget for the widget view displayed in dashboard panel 122.

Supported account types 404 is an indication of one or more types of accounts a user may use for authentication with the service associated with the widget. For example, widget manifest 322A (FIG. 3), associated with first widget 126A, may indicate one or more account types for a user to use to be authenticated with first service 112A at first server 104A. Using a valid account of one of the supported account types, data related to first widget 126A may be retrieved from first service 112A. Any number of different types of supported account types may be indicated. Examples of such accounts include a MSA (Microsoft® account), an AAD (Azure® Active Directory®) account, a Facebook® account, a Google account, etc. Such accounts may be made by an account manager of the OS, such as Web Account Manager of Microsoft® Windows®, etc.

Size data 406 indicates one or more sizes available for selection for the widget frame when displayed in dashboard panel 122, including a default size. For instance, first widget 126A may have four display sizes, including small (e.g., 300×200 pixels), medium (e.g., 300×304 pixels), large (e.g., 300×412 pixels), and extra large (e.g., 300×516), with medium being the default size. In other examples, another size may be indicated as default, or dashboard panel application 118 may determine the default size.

Image files 408 include one or more image files corresponding to possible display views of the widget (e.g., a background view of the widget). For example, as shown in FIG. 4, image files 408 may include a default widget image 430, a data loading widget image 432, a normal widget image 434, and an error image 436. In such an embodiment, the widget may have view states that utilize the image files, including a default state that corresponds to default widget image 430, a placeholder state that corresponds to data loading widget image 432, a normal state that corresponds to normal widget image 434, a stale state that corresponds to normal widget image 434 also displaying a last update timestamp, and an error state that corresponds to error image 436. These example widget view states are described in further detail as follows. Note that an icon image file for the widget may optionally also be indicated in widget manifest 400.

Default state: This state defines how the widget appears with no configuration. Even without configuration, a widget's default state image may be personalized in some manner. For example, the default state image of a weather widget may show the user's local weather (e.g., based on a global positioning signal (GPS) providing a location of computing device 102 (FIG. 1)). In an embodiment, a widget that requires configuration to be functional may show a default visual that shows a call to action. For example, a social media widget that requires a user account to be entered to enable showing show custom content may display a default state image that include a logo for the corresponding social media company and a message indicating user account information needs to be entered.

Placeholder state: This state defines what the widget displays when data is loading. The data loading widget image for this state may mimic the normal state with graphics and/or data fields shown blotted out (e.g., shown as rectangular shaded regions) instead of actual content. The image for this state may be shown the first time a widget appears, when no service data for the widget is yet cached, and while the service data is being retrieved.

Normal state: This state defines how the configured, up-to-date widget appears. Each widget may have a refresh strategy. On invocation, dashboard panel 122 displays the normal widget image with cached service data (content). An API (application programming interface) enables a widget to determine when dashboard panel 122 is being shown, such that the widget can refresh its content as desired. If the widget is up to date, new data is not needed to be retrieved from the corresponding service. If the widget has passed its update cadence and/or if new data is available, new data may be retrieved from the service for the widget.

Stale state: This state defines how the widget appears when the current displayed widget data is stale, and new data cannot be retrieved (e.g., due to a connection issue). In an embodiment, a widget in this state displays a timestamp in the header indicating the last time at which the data was refreshed. An API may be provided by dashboard panel application 118 to determine this time. Dashboard panel application 118 may convert this time into a string for display in the widget header in dashboard panel 122 in a consistent format.

Error state: This state defines how the widget appears during an error. Note that in one embodiment, the error image is provided by in the widget manifest, and in another embodiment, a same error image is used for all widgets, except that the relevant widget title (and icon) may be displayed in the error image. Various error scenarios may be covered by the error state, such as a failure by dashboard panel application 118 to navigate to the widget's content at the corresponding service, and/or the widget being unable to receive a valid authentication token during authorization of the widget. A reload button may be interacted with to reinitiate the authentication flow. As such, in an embodiment, dashboard panel 122 may display the widget view with the error image overlaid with the widget header, an error message, and a reload button.

Referring back to FIG. 4, widget ID 410 is a value that identifies the corresponding widget. In an embodiment, the widget ID may be expressed in reverse DNS (domain name service) notation. In other embodiments, any suitable identifying alphanumeric identifier value may be used. Widget ID 410 may be used in various ways, including in communications with remote services, in tracking/identifying the widget in dashboard panel 122, for determining an order of widgets in a widget list generated by widget selector 312, etc.

Minimum dashboard version supported 412 is an indication of the minimum version of dashboard panel application 118 that supports the widget (e.g., for compatibility purposes).

Maximum number of widget instances 414 is an indication of the maximum number of instances of the widget that can be simultaneously displayed in dashboard panel 122.

Network address (for service) 416 is an indication of an entry point for the service corresponding to the widget. For instance, network address 416 may be a HTTPS (hypertext transfer protocol secure) URL to a file (e.g., a JavaScript .js file) at the service that contains a script for an initialization contract between the service and dashboard panel application 118. In an embodiment, the initialization contract instantiates the widget and enters the widget in the DOM (document object model) code descriptive of dashboard panel 122 for rendering, as described in further detail below. Furthermore, the initialization contract may define contracts for widget settings and state.

Widget properties 418 include any number of parameters that are specific to the widget, and that may be available to the widget at initialization and runtime. Examples of such properties may include stock values parameters (for a stock widget), favorite team parameters (for a sports widget), etc.

Referring back to step 206 of flowchart 200 in FIG. 2, after the network address for the widget service is determined, the account credentials set for the widget may be transmitted to the service (at the network address) so that the user may be authenticated to the service. For instance, with reference to FIGS. 1 and 3, service data retriever 304 may access network addresses indicated in widget manifests 322A, 322B, etc. for the user-selected widgets indicated in configuration information 314. First service request 132 may be transmitted by service data retriever 304 (using communication circuitry of computing device 102) through network 108 to first service 112A at server 104A. First service request 132 may include the account credentials set for first widget 126A for authentication purposes. In an embodiment, a token may be provided by an account manager of OS 116 in service request 132 that includes the account credentials that were associated by the user with first widget 126A and first service 112A. The token may include account credentials (user identifier and password) that take part in a single sign-on (SS) authentication scheme that allows a user to log in with a single ID and password to any of several related, yet independent, software systems, or may include account credentials specific to first service 112A. The token may be transmitted by service data retriever 304 to first service 112A to authenticate the user at first service 112A on behalf of first widget 126A in first service request 132. Furthermore, service data retriever 304 may access user-specified widget customization data in configuration information 314 to transmit to first service 112A if needed, so that first service 112A may customize returned service data for the user based on the widget customization data. Examples of such user-specified widget customization data may include a favorite sports team, stock ticker symbols, movie preferences, etc.

It is noted that in an embodiment, different account credentials may be used for different widgets, including different account credentials of a same user for multiple instances of a same widget (e.g., work account credentials of a user for a first instance of a calendar widget, and personal account credentials of the user for a second instance of the calendar widget). For example, in step 206, first account credentials may be transmitted to first service 112A on behalf of first widget 126A, and second account credentials may be transmitted to second service 112B on behalf of second widget 126B, where the first and second account credentials are different from each other (e.g., a different login identifier). In step 208, corresponding service data may be received from first and second services 112A and 112B for first and second widgets 126A and 126B, respectively. In this manner, widgets of various services may be presented to a user in a common dashboard panel 122 at the same time, despite requiring different account credentials, enabling the user to be presented with a wider variety of data, as compared to conventional systems using a common account credentials for all widgets.

In step 208, widget data associated with the widgets is received from the server-hosted services. In an embodiment, after the user is authenticated at a widget service according to step 206, the service may transmit data for the widget back to dashboard panel application 118. For instance, with reference to FIG. 1, in response to request 132, first service 112A generates first widget service data signal 134 that is transmitted from first server 104A through network 108 to dashboard panel application 118. Service data transported by first widget service data signal 134 may be customized by first service 112A for first widget 126A according to the user-specified widget customization data received for each present widget, such by providing weather information for the user's location, sports news for the user's favorite sports team, a selection of movies made according to the user's movie preferences, etc. Similarly, service data related to second widget 126B may be retrieved from second service 112B.

Note that steps 206 and 208 may be performed for any number of widgets selected by the user for inclusion in dashboard panel 122, including first widget 126A, second widget 126B, etc. In this manner, service data for all the user-selected widgets of dashboard panel 122 is retrieved by service data retriever 304 for display. As shown in FIG. 3, service data retriever 304 outputs service data 318, which includes service data received for all widgets. In an embodiment, service data 318 may be stored in storage 144. As shown in FIG. 3, service data 318 may include first widget service data 324A retrieved for first widget 126A, second widget service data 324A retrieved for second widget 126B, and service data retrieved for further widgets.

In step 210, a view of the dashboard panel is composed that includes views of the widgets incorporating the widget data. In embodiments, dashboard panel composer 306 receives service data 318 retrieved by service data retriever 304, accesses configuration information 314, and accesses widget library 316. Dashboard panel composer 306 is configured to compose a document that describes a view of each widget for rendering. For example, in an embodiment, dashboard panel composer 306 is configured to generate a dashboard panel view 326 that is an XML document, an HTML document, or other format document that contains DOM code descriptive of dashboard panel 122 for rendering. In this manner, a rendering engine may be used to render the DOM code into dashboard panel 122.

In embodiments, to compose dashboard panel view 326, dashboard panel composer 306 accesses widget manifests in widget library 316 for descriptions of each present widget, including an image for a widget's particular state, any widget-specific properties, and any further widget parameters described above with respect to FIG. 4 or otherwise known. Furthermore, dashboard panel composer 306 accesses configuration information 314 for any user-specified widget customization data for each present widget, such preferred widget display size, etc. Still further, dashboard panel composer 306 accesses service data 318 for each present widget to customize views of the widgets with the retrieved service data, such as by filling in corresponding display fields. For instance, for a weather widget, dashboard panel composer 306 may compose the widget view to include the weather information determined for a user-specified location. For a sports widget, dashboard panel composer 306 may compose the widget view to include the sports news determined for the user's favorite sports team. For a streaming video widget (e.g., a widget for Netflix®, Hulu®), dashboard panel composer 306 may compose the widget view to include the selection of movies determined according to the user's movie preferences.

In step 212, the dashboard panel view is caused to be rendered on the base graphical canvas. In an embodiment, dashboard panel renderer 308 receives dashboard panel view 326 (e.g., in document form), and causes dashboard panel view 326 to be rendered into dashboard panel view 328 (e.g., in the form of pixel data). For example, with reference to FIG. 1, dashboard panel 122 is displayed based upon dashboard panel view 326 and includes rendered views of first through nth widgets 126A-126N. Rendered dashboard panel view 326 may be rendered in the form of a dashboard panel frame, which may be rectangular in shape (or other shape), inside of which each widget view may be rendered in a separate frame (or “card”), which may be rectangular (or other) in shape. In other embodiments, rendered dashboard panel view 326 may have other forms.

In an embodiment where dashboard panel view 326 has the form of a DOM document, dashboard panel renderer 308 may include a rendering engine similar to that of a web browser but without other browser functionality (e.g., without a browser user interface) to conserve resources. In this manner, the rendering engine may be caused to perform page layout and rendering of content within each widget view frame. Examples of applicable rendering engines include Gecko™ used in the Mozilla Firefox® web browser, the WebKit™ engine used by the Apple Safari browser, Trident™ (MSHTML) used in Internet Explorer™, and Blink™ used in the Google Chrome and Microsoft Edge Browsers. In another embodiment, dashboard panel renderer 308 accesses a rendering engine external to dashboard panel application 118 to cause dashboard panel view 326 to be rendered.

Note that steps 204-212 may be repeated periodically. For example, step 202 of flowchart 200 may be performed to initiate dashboard panel application 118 and render an initial view of dashboard panel 122, and subsequently dashboard panel 122 may be updated and re-rendered in the updated form. Step 204 may be repeated based on the already user selected widgets, and on any further widgets selected by the user since the last time dashboard panel 122 was rendered. Steps 206 and 208 may be repeated to retrieve updated service data for the widgets, and steps 210 and 212 may be repeated to update the rendered view of dashboard panel 122, including updating the rendered views of the widgets within. Steps 204-212 may be repeated in response to an interaction of the user with dashboard panel 122 (e.g., selecting a refresh UI), on a periodic basis (e.g., every 15 minutes), and/or in another manner. In another embodiment, each widget may be individually refreshed according to a schedule indicated for the widget (e.g., in the widget manifest), according to a signal received from the corresponding service, based on the user interacting with a refresh UI control of the widget, or on another basis, by retrieving updated service data for the widget (by steps 206 and 208), then re-rendering dashboard panel 122 with the updated service data for the widget (by steps 210 and 212).

Accordingly, views of a variety of widgets may be displayed within dashboard panel 122, in respective view frames with corresponding varieties of data. Such a rendered dashboard panel may be arranged in various ways.

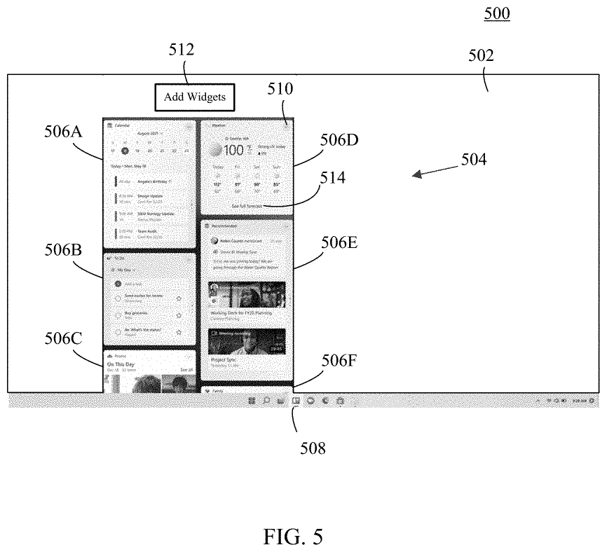

For instance, FIG. 5 shows a dashboard panel 504 displayed over a base graphical canvas 502 on a display screen 500, according to an example embodiment. Display screen 500 is an example of display screen 110 of FIG. 1, base graphical canvas 502 is an example of base graphical canvas 120, and dashboard panel 504 is an example of dashboard panel 122. As shown in FIG. 5, dashboard panel 504 includes view frames 506A-506F and a UI control 512. Dashboard panel 504 has a generally rectangular shape, though in other embodiments, dashboard panel 504 may have other shapes. Furthermore, view frames 506A-506F are shown arranged in two columns, although in other embodiments, view frames 506A-506F may be arranged in other numbers of columns, or may alternatively be arranged in any number of rows. Furthermore, additional widgets may be displayed in dashboard panel 504 that are not visible in FIG. 5. Such additional widgets may become visible by scrolling downward (or by scrolling horizontally when the widgets are arranged in rows).

In FIG. 5, each of widget frames 506A-506F contains a view of a respective widget. For example, view frame 506A contains a view of a calendar widget, view frame 506B contains a view of a to-do list widget, view frame 506C includes a view of a photos widget (partially shown in FIG. 5), view frame 506D contains a view of a weather widget, view frame 506E contains a view of a recommendations widget, and view frame 506F contains a view of a family widget (partially shown in FIG. 5). Each of view frames 506A-506F has a generally rectangular shape (with rounded corners), and each having its default display size, a display size selected by the user during their customization of the widget, or a dynamically determined display size (e.g., a size determined based on an amount of information to be displayed). The contents of each view correspond to the content the widget developer coded for display for the particular widget, and contains service data retrieved for the widget from the corresponding service. Examples of the retrieved service data include appointment information retrieved for the calendar widget of view frame 506A, task data retrieved for the to-do list widget of view frame 506B, photo images retrieved for the photos widget of view frame 506C, temperature data retrieved for the weather widget of view frame 506D, recommendations retrieved for the recommendations widget of view frame 506E, etc.

In an embodiment, widgets, such as widgets 506A-506F, may have a custom or a standardized display format. For instance, in a standardized display format example, each widget may have a full background image, margins at all four edges, with each edge having a predetermined width in pixels, an application attribution area (e.g., a header region along the length of the top edge), and a content area within the margins. In other embodiments, widgets may have other standardized display formats. In an embodiment, clicking the attribution area may cause the widget's application to be invoked or website to be launched (both being invoked outside of dashboard panel application 118) as specified in the widget manifest. Alternatively, a widget may have a custom display format in which a user is enabled to configure display aspects of the widget, such as a border thickness, a background color, information shown on the widget (e.g., choosing a different city for a weather widget or adding stocks to a watchlist), etc.

UI control 512 is a UI element (e.g., a graphical button) that a user can interact with to add additional widgets to dashboard panel 122, as further described below. UI control 512 is shown displayed above dashboard panel 504 in FIG. 5. In other embodiments, UI control 512 may be displayed to the right, left, below, or within dashboard panel 504.

Furthermore, as described herein, a widget may be interacted with to access further information regarding the widget, such as by invoking a web page at a website associated with the widget that provides the further information. For instance, as shown in FIG. 5, the view of the weather widget in view frame 506D includes a UI control 514. UI control 514 may be interacted with by a user to bring up further information. For example, interacting with UI control 514 may cause a URL indicated in the widget's manifest (e.g., a URL indicated in widget properties 418) to be navigated to, resulting in a web page addressable by the URL to be opened as web content 146 in an invoked instance of web content pane 128 of FIG. 1. A rendering engine of or external to dashboard panel renderer 308 may render the web page as web content 146. In this example, the web page may show more detailed weather information for the user's location. Furthermore, if the user interacts with the web page displayed as web content 146 (e.g., clicks on a URL displayed therein), a web browser independent of dashboard panel application 118 may be invoked to render any resulting invoked content in a web browser window outside of dashboard panel 122. Any interactions with this resulting invoked content may be managed by the web browser outside of the scope of dashboard panel application 118.

Alternatively, UI control 514 may be interacted with by a user to invoke an application associated with the widget and installed on computing device 102. The application is invoked outside of dashboard panel 122 and may be thereafter interacted with by the user outside of dashboard panel application 118. Note that in an embodiment, a widget may enable one-click actions. For instance a user may be enabled to approve a screen time request from child by clicking on a UI control displayed within a family widget; a user may be enabled to click on a join meeting UI control within a web conferencing widget; or a user may be enabled to click on a to-do item displayed within a tasks widget to indicate item completion. Respective indications of the selected one-click actions (and/or other actions) may be transmitted to the respective service (e.g., first service 112A or second service 112B) over a network (e.g., network 108 of FIG. 1) using a corresponding communication signal. Further widget one-click actions will be apparent to those skilled in the relevant art(s) from the teachings herein.

Note that UI controls 512 and 514 may be of any suitable type, including a pointer-clickable button (as in FIG. 5), a pull-down menu, a pop-up menu, etc. Such user input may be provided in other ways, including activation by voice command, etc.

As illustrated by the embodiment of FIG. 5, the displayed widgets have various advantages and offer improvements for human-computer interaction. For instance, the widgets of view frames 506A-506F are “glanceable,” meaning that users gain value by being shown service data presented in a form which can be ascertained with even a quick look. A UI control, such as UI control 514, may be interacted with if further detailed information is desired for a particular widget. The widgets are personal, providing personalized content that is relevant for the user and may build an emotional connection with the user. Furthermore, the user is control of their widget content and layout via customization options, described in further detail herein. The widgets are useful, elevating relevant information. The widgets are focused, with each widget generally focusing on a main job-to-be-done. The widgets are up-to-date, in that widget content is dynamically refreshed based on available context and provides desired content at the right time. Furthermore, the widgets are dependable, surfacing information quickly via interactions with services to save the user time associated with having to repeat those steps.

As mentioned with respect to FIG. 5, a user may select widgets for addition to a dashboard panel. Such addition enables a user to configure the dashboard panel to include the widgets the user desires to see, and to add new widgets as they become available. Such selection of additional widgets may be performed in various ways.

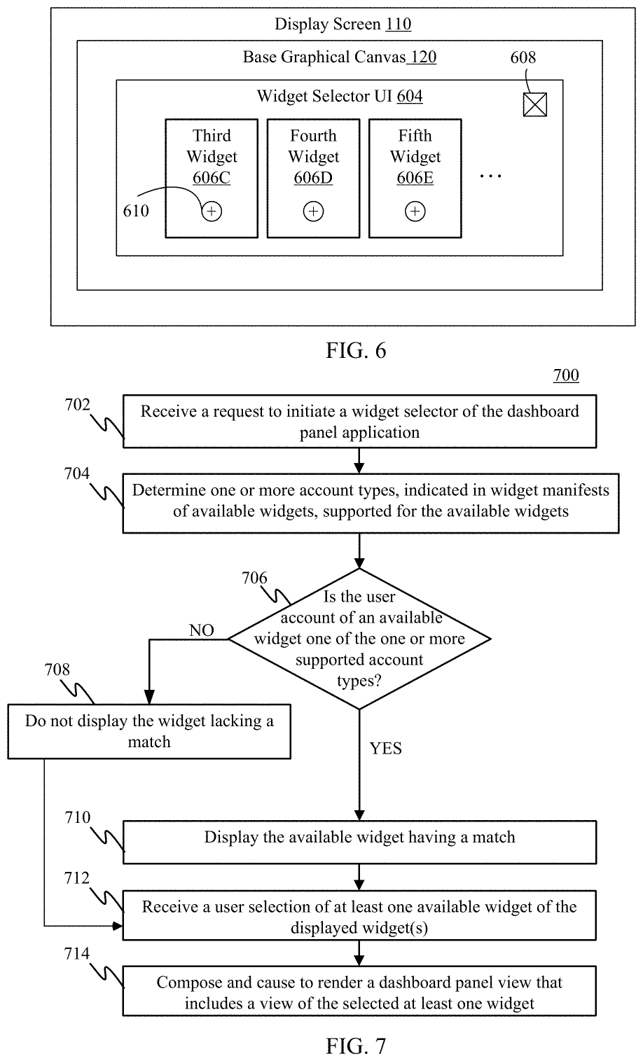

For instance, FIG. 6 shows display screen 110 displaying a widget selector UI 604 in accordance with an example embodiment. Widget selector UI 604 may be generated by widget selector 312 (FIG. 3) for user-selection of widgets. Widget selector UI 604 and widget selector 312 are described as follows in relation to FIG. 7. FIG. 7 shows a flowchart 700 of a method of selection of a widget for a dashboard panel, according to an example embodiment. Other structural and operational embodiments will be apparent to persons skilled in the relevant art(s) based on the following discussion regarding flowchart 700.

Flowchart 700 of FIG. 7 begins with step 702. In step 702, a request is received to initiate a widget selector of the dashboard panel application. In embodiments, a widget selector may be initiated in response to a received request various ways. For example, with reference to FIG. 5, computing device 102 (FIG. 1) may initiate a widget selector in response to a request received by user interaction with UI control 512, such as by the user clicking with a pointer on UI control 512. With reference to FIG. 3, widget selector 312 may be invoked by computing device 102 in response to user interaction with UI control 512, causing widget selector UI 604 to be displayed.

In step 704, one or more account types indicated in widget manifests of available widgets supported for the available widgets are determined. In step 706, whether the user account is one of the one or more supported account types is determined. These two steps are described together as follows.

In an embodiment, widget selector 312 performs steps 704 and 706 so as to avoid displaying widgets that the user is prohibited from selecting, such as due to the user not having an account type supported by the widget. As such, in step 704, widget selector 312 determines for each available widget the account types supported by the widget. For instance, widget selector 312 may access the widget manifest for each widget, such as a third widget manifest in widget library 316 for a third widget, to determine the corresponding supported account types as indicated in supported account types 404 (FIG. 4). Examples of possible supported account types includes MSA (Microsoft® account), an AAD (Azure® Active Directory®) account, a Facebook® account, a Google account, etc. In step 706, widget selector 312 compares, for each available widget, the determined supported account type(s) to the account type of the current logged user account. For any widgets having a supported account type matching that used to log into dashboard panel application 118, operation of flowchart 700 proceeds from step 706 to step 710. For any widgets not having a supported account type matching the logged in user account, operation of flowchart 700 proceeds from step 706 to step 708.

In step 708, the widget lacking a match is not displayed by the widget selector. In step 710, the available widget having a match is displayed. In an embodiment, widget selector 312 is caused to render widget selector UI 604 (which may be displayed overlaying dashboard panel 122 of FIG. 1) on base graphical canvas 120. Any available widgets in widget library 316 having a supported account type matching that of the logged in user account are displayed in widget selector UI 604. Any available widgets in widget library 316 not having a supported account type matching that of the logged in user account are not displayed in widget selector UI 604. Alternatively, available widgets in widget library 316 not having a supported account type matching that of the logged in user account may be displayed in a separate display frame or other area, or may be otherwise visually distinguished (e.g., grayed out) from available widgets having a supported account type, and may enable the user to provide user account information. For example, in FIG. 6, third through fifth widgets 606C-606E (and potentially further widgets) may be determined to have supported account types matching the type of the current user account, and thus are displayed as selectable in widget selector UI 604. Each displayed widget may be shown by title, as a selectable icon, and/or based on any further suitable information retrieved from the corresponding widget manifest.

In step 712, a user selection is received of at least one available widget of the displayed widget(s). In an embodiment, the user may select any of the displayed widgets in widget selector UI 604, such as third widget 606C, including any number of displayed widgets. The user may select a displayed widget in any manner, such as by voice command, by a pointer click on the displayed selectable widget, by pointer click on a widget adder control displayed within the selectable widget such as UI control 610, or in another suitable manner. In an embodiment, an entry is made in configuration information 314 (FIG. 3) for each user selected widget to receive customization data as further described below.

In step 714, a dashboard panel view is composed and caused to be rendered that includes a view of the selected at least one widget. In an embodiment, after the user selects one or more available widgets, dashboard panel 122 may be recomposed and rendered with the selected widget(s) according to steps 210 and 212 of FIG. 2. For instance, FIG. 8 shows a flowchart 800 of a method of rendering and customizing widgets in a dashboard panel in accordance with an example embodiment. Flowchart 800 is described as follows with reference to FIGS. 1, 3, and 5 for illustrative purposes. Other structural and operational embodiments will be apparent to persons skilled in the relevant art(s) based on the following discussion regarding flowchart 800.

Flowchart 800 of FIG. 8 begins with step 802. In step 802, a second view of the dashboard panel is composed that includes the views of the previous widgets including a first widget and a second widget and views of selected available widgets including a third widget. With reference to FIG. 3, by access to configuration information 314, widget library 316, and service data 318, dashboard panel composer 306 is configured to compose a document that describes a view of each widget for rendering, including any previously selected widgets (such as first and second widgets 126A and 126B of FIG. 1) and any widgets newly added (e.g., a third widget) by user interaction with widget selector 312.

For example, as described above, dashboard panel composer 306 may generate dashboard panel view 326 that contains DOM code. To compose dashboard panel view 326 as a second dashboard panel view containing added widgets, dashboard panel composer 306 accesses widget manifests in widget library 316 for descriptions of each widget, previously selected and newly selected, including an image for a widget's particular state, any widget-specific properties, and any further widget parameters described above with respect to FIG. 4 or otherwise known. Furthermore, dashboard panel composer 306 accesses configuration information 314 for any user-specified widget customization data for each present widget, such preferred widget display size, etc. For newly added widgets, a user may not yet have added customization data. As such, the newly added widgets are generated based on initial data included in or indicated by the corresponding widget manifest, such as default widget image 430 shown in FIG. 4, which may include a call-to-action for the user to customize the widget. Still further, dashboard panel composer 306 accesses service data 318 for any previously present widgets to customize views of those widgets, which may include cached service data from a prior time a widget was displayed or newly retrieved service data.

In step 804, the second dashboard panel view is caused to be rendered on the base graphical canvas, the view of the second widget providing a UI control configured to enable customization of the third widget. With reference to FIG. 1, dashboard panel 122 may be a second (or subsequent) rendering of dashboard panel view 326 to include rendered views of the previously selected widgets (e.g., first and second widgets 126A and 126B) and any newly added widgets (e.g., the third widget).

Note that in an embodiment, newly added widgets may be rendered to be displayed at the bottom of widget pane 124 (after the previously present widgets), or in another embodiment, rendered to be displayed at the top of widget pane 124. In another embodiment, the newly added widgets may be rendered for display in other positions, such as being inserted alphabetically into an alphabetical widget ordering, being included in a widget subject category, etc. Furthermore, note that dashboard panel 122 may be configured to enable displayed widgets to be reordered by the user, such as by the user dragging and dropping the widgets into revised positions.

In step 806, user provided customization data is received for the third widget by interaction with the UI control. In embodiments, a user may be enabled to customize a newly added widget, as well as to modify the configuration of a previously customized widget. A user may be enabled to provide customization data for a widget in various ways. For instance, with reference to FIG. 5, a UI customization control of a widget, such as UI control 510 in the header region of widget 506D, as may be interacted with by a user, such as by clicking with a pointer on UI control 510. The interaction with UI control 510 causes a widget configuration tool to be initiated so that the user can customize widget 506D, which may have been previously customized or not. In the example of FIG. 3, the interaction causes widget selector 312 of dashboard panel application 118 to be invoked. Widget selector 312 is configured to open a widget customization UI that enables the user to customize customizable features of widget 506D.

In embodiments, the widget customization UI may have any form, including a pop-up window with selectable controls. For instance, in the case of a selectable widget size, the text selections of “Small”, “Medium,” and “Large” may be displayed, from which one may be interacted with to select the corresponding display size for the widget. Such sizes may correspond to the image files present in the widget manifest. Furthermore, a “Remove widget” selection may be displayed with which a user may interact to delete the widget from the dashboard panel. Still further, additional customization selections may be present in the widget customization UI and/or a “Customize widget” selection may be displayed with which a user may interact to perform further customizations of the widget. Such customizations may include one or more of a location setting, a user account to be used for the widget (which may be, for example, user-entered via keyboard, or selected from a list of accounts known to the operating system's account manager), and any other widget settings.

Note that any customizable settings for a widget may alternatively be set within the widget selector UI 604 immediately after selection of the widget for inclusion in dashboard panel 122. Any customization settings received via widget selector 312 and/or widget configurer 310 are stored in configuration information 314. For example, customization settings applied to first widget 126A (FIG. 1) are saved in first widget customization data 320A. In an embodiment, configuration information 314 may be stored in storage 144 of computing device 102, and/or may be stored in cloud storage.

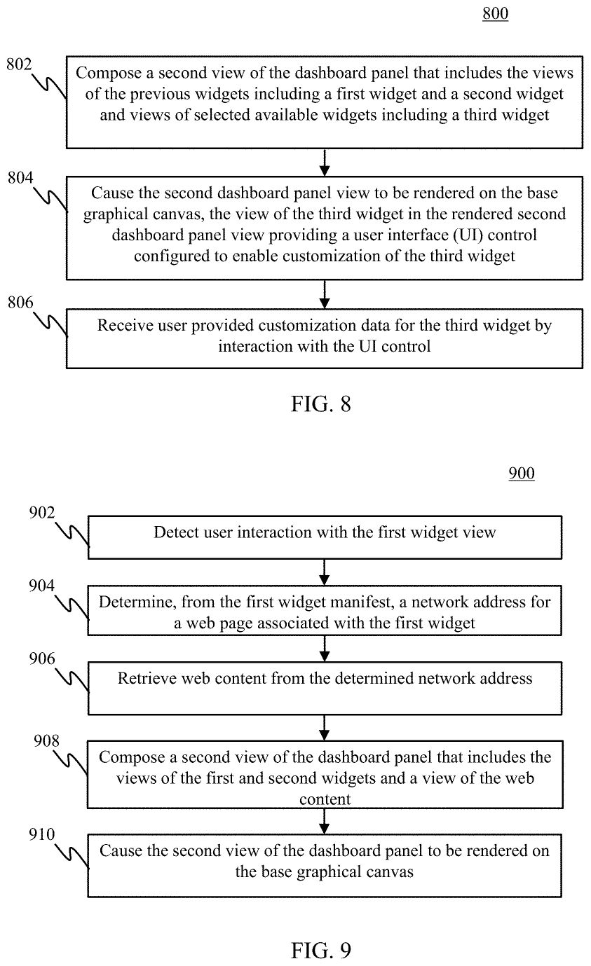

As mentioned above, a user may interact with a displayed widget to cause a web content pane to be displayed that shows further information regarding the widget. This display of the web content pane may be enabled in various ways. For instance, FIG. 9 shows a flowchart 900 of a method of displaying web content with respect to a widget in a dashboard panel in accordance with an example embodiment. Flowchart 900 is described as follows with reference to FIGS. 1, 3, and 5 for illustrative purposes. Other structural and operational embodiments will be apparent to persons skilled in the relevant art(s) based on the following discussion regarding flowchart 900.

Flowchart 900 of FIG. 9 begins with step 902. In step 902, user interaction with the first widget view is detected. For instance, as shown in FIG. 5, UI control 514 in widget frame 514 may be interacted with by a user to bring up further information regarding the widget in which UI control 514 is included.

In step 904, a network address for a web page associated with the first widget is determined from the first widget manifest. For example, interacting with UI control 514 of FIG. 5 may cause a URL indicated in the widget's manifest as a landing point for further widget information (e.g., a URL indicated in widget properties 418) to be retrieved.

In step 906, web content is retrieved from the determined network address. In an embodiment, service data retriever 304 may be configured to navigate the network address (e.g., URL) to retrieve a web page document.

In step 908, a second view of the dashboard panel is composed that includes the views of the first and second widgets and a view of the web content. As described above, dashboard panel composer 306 is configured to generate a dashboard panel view 326, which includes DOM code descriptive of dashboard panel 122. Dashboard panel composer 306 may compose this DOM code to include both widget pane information corresponding to the user-selected widgets as well as web content page information corresponding to the retrieved web page document. Alternatively, dashboard panel composer 306 may compose a second DOM code that includes just the retrieved web page document.

In step 910, the second view of the dashboard panel is caused to be rendered on the base graphical canvas. As described above, dashboard panel renderer 308 may cause the composed DOM code to be rendered into widget pane 124. Furthermore, dashboard panel renderer 308 may cause the retrieved web page document portion of the DOM code, or separately generated second DOM code corresponding to the retrieved web page document, to be rendered into the web content pane 128 that includes the retrieved web page document rendered as web content 146. In the weather widget example, the web page may show more detailed weather information for the user's location. However, if the user interacts with the web page displayed as web content 146 (e.g., clicks on a URL displayed therein), a web browser independent of dashboard panel application 118 may be invoked to render any resulting invoked content in a web browser window outside of dashboard panel 122. Any interactions with this resulting invoked content may be managed by the web browser outside of the scope of dashboard panel application 118.

As such, dashboard panel application 118 provides many benefits by presenting widgets to users via dashboard panel 122. Furthermore, note that a widget developer can offer multiple types of widgets for the same service or application. Each widget may represent a particular aspect of the service or application's purpose. For example, a family widget can have a first widget that shows a single child and their driving history. A second widget can show the locations of all of the family members.

As mentioned, a widget can support multiple instances. Users can add multiple instances of the same widget. Each separate instance of the widget displayed in a dashboard panel has its own configuration information (customization data). For example, two family widgets may be customized for two children, and two weather widgets may be customized for two cities. When a new instance of a widget is added, it first shows up in the default state, and a user can then go to the widget customization page to configure it differently. Maximum number of widget instances 414 shown in FIG. 4 may be used by dashboard panel application 118 to constrain the number of instances to the indicated number.

A widget may be configured to display relevant content by default before customization. For example, a family widget could show information about one child by default, before the user has chosen for which child they want to the widget to display information. The user can then customize the widget and select which child they prefer to see information about. Likewise, a weather widget may local information by default, and a stock widget may show major market indexes by default before enabling users to customize.

In an embodiment, when dashboard panel application 118 is invoked “cold” before a widget has downloaded any service data, dashboard panel application 118 attempts to navigate to the widget's endpoint for service data (content). If able to obtain content, the widget view is caused to be rendered in the dashboard panel with up-to-date content. If unable to obtain content, dashboard panel application 118 causes the widget view to show the widget's error state because there will be no cached content.

In an embodiment, when dashboard panel application 118 has been previously invoked, the dashboard panel displays content from a last service data refresh. Widgets may be configured to determine when the dashboard panel is visible to users through an API. A widget may be configured to keep its content fresh, or to communicate to the user if the content is stale by displaying a timestamp in the widget of last time of update.

In an embodiment, when the dashboard panel is not visible, each widget's refresh timer may be configured to fire when the dashboard panel is unsuspended. When a widget's refresh timer fires, the widget determines whether it needs to refresh according to its refresh strategy. For example, program code of the widget may be configured to perform the refresh strategy of the widget, while the widget is displayed in the dashboard panel, such as being configured to fire the refresh timer and perform a real-time update of the widget according to any suitable frequency.

In an embodiment, dashboard panel application 118 is configured to check for a network connection before refreshing displayed widgets. If there is no network connection, dashboard panel application 118 may be configured to cause to render a Global Offline State. An API may be available for widgets to determine whether the user is offline. No action is required from widgets when the user is offline. Because dashboard panel application 118 may check for a network connection before refreshing, in the scenario where the user has dashboard panel application 118 open and loses connection for a short amount of time (e.g., 10 seconds), the UI does not suddenly switch to the Global Offline State.

In some embodiments, a widget may support pagination to handle content overflow or navigate between similar types of content. For instance, UI controls, such as arrows, may be displayed to enable users to paginate between different items associated with the widget. For example, the navigation arrows in a photos widget can navigate to other photos.

In embodiments, to respect users' privacy settings with each service, dashboard panel application 118 may be configured to not pass location information to widgets. Widgets may be managed to honor whichever location/privacy settings their service already has. Privacy settings for a widget may be controlled by its corresponding service. Users may be enabled to opt in or out of sharing particular information for any services, including all services, as desired, as well as being enabled to control display of shared data, to correct data, and/or perform other functions with regard to data privacy and privacy settings.

In embodiments, developers are enabled to register their widgets with dashboard panel application 118. For instance, each widget owner/developer may provide a widget manifest (e.g., a JSON file of metadata) with a designated name, such widget_manifest.json. The manifest, and any assets (e.g., image files) pointed to by it, are provided for incorporation into dashboard panel application 118, and may be provided as part of the above-mentioned initialization contract. These files are known as registration files. In an embodiment, developers may be allowed to provide updated widget manifests that replace existing widget manifests to enable modified (e.g., increased, decreased) widget functionality.

### III. Dashboard Explore Mode

In some embodiments, in addition to, or alternatively to, displaying widgets, a dashboard panel application may display content from other sources, such as a content feeds service (e.g., a news feeds service). For example, the dashboard panel application may be configured to display headlines from online news articles, highlights from various webpages, weather data from a weather application, sports data, financial data, blog posts, etc. A feeds service may aggregate content from a plurality of content sources. In some embodiments, the feeds service may be configured to identify content that is relevant to a user or an account based on an account profile. The account profile may include explicit or implied user preferences, geographic location information, demographic information, etc. The feeds service may be executed on the local computing device on which the content is to be surfaced (e.g., the client), in the cloud, or partially locally and partially in the cloud. The content feeds service may be configured to communicate with one or more services that aggregate content, to obtain content to be displayed in a dashboard panel at a user computing device. In some embodiments, a user may select from one or more user accounts to access content from the content feeds service (e.g., by entering, or selecting from, user account information in a dashboard UI settings menu). Moreover, in some embodiments, the same user account information that is utilized to retrieve service data for the widgets may be utilized to access content from a content feeds service.

In some embodiments, dashboard panel 118 may be configured to manage a content immersion experience by facilitating context continuity that allows a user to scroll through headlines and highlights from multiple endpoints, delve deeper into a topic that catches their interest, and concurrently continue to skim the headlines from where they left-off. The content immersion experience may be administered by presenting scrollable content cards (e.g., feed service cards and/or widgets) and, in response to a selection of a content card, surfacing side by side panes including one pane with the scrollable content cards and an independently scrollable content immersion view pane comprising additional or expanded content associated with the selected content card.

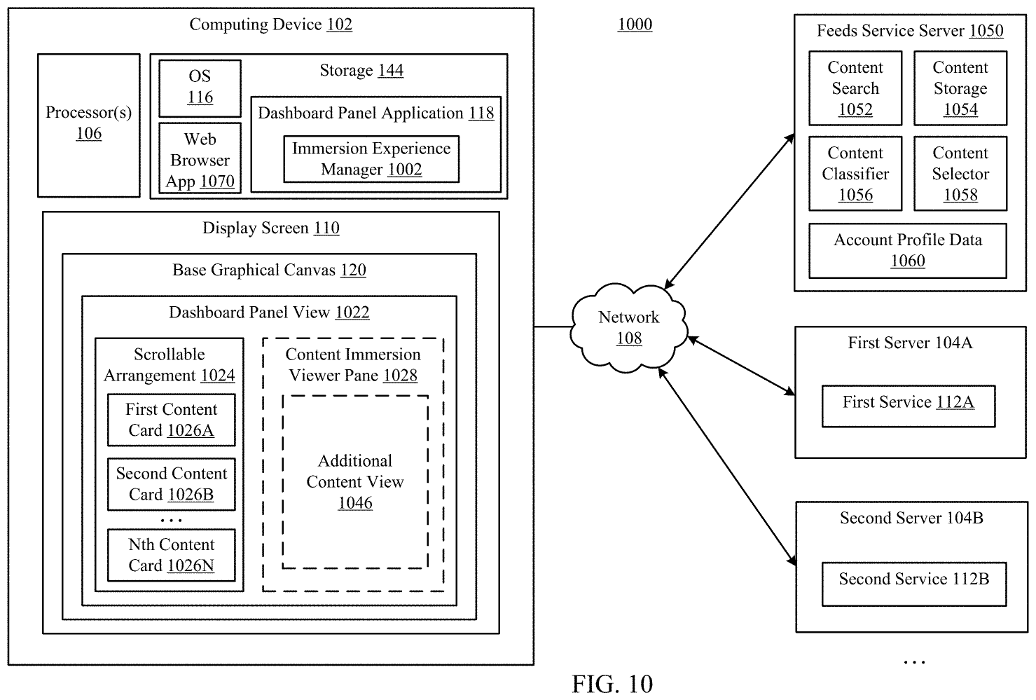

For instance, FIG. 10 shows a block diagram of a system 1000 for rendering a dashboard that includes scrollable content cards and a content immersion pane, according to an example embodiment. As shown in FIG. 10, system 1000 includes computing device 102, a feeds service server 1050, first server 104A, and second server 104B, which are communicatively coupled to each other via network 108. Computing device 102 comprises one or more processors 106, storage 144, and display screen 110. Storage 144 stores operating system (OS) 116, dashboard panel application 118, an immersion experience manager 1002, and a web browser application 1070. Display screen 110 comprises base graphical canvas 120, a dashboard panel view 1022, a scrollable arrangement of content cards 1024, which may be referred to as scrollable arrangement 1024, and a content immersion viewer pane 1028. Scrollable arrangement 1024 may comprise a first content card 1026A and a second content card 1026B through an Nth content card 1026N, which may be referred to as content cards 1026A-1026N. Content immersion viewer pane 1028 comprises an additional content view 1046. Feeds service server 1050 hosts a content search engine 1052, a content storage 1054, a content classifier 1056, a content selector 1058, and account profile data 1060. As described above, first server 104A hosts first service 112A and second server 104B hosts second service 112B. These features of system 1000 are described in further detail as follows.

Dashboard panel application 118 is described above with respect to composing and rendering widgets in dashboard panel 122, however, dashboard panel application 118 may be additionally configured to compose and cause rendering of various types of content cards such as content feed cards that may display data received from feeds service server 1050. Feeds service server 1050 may be configured to retrieve and aggregate content (e.g., news articles, webpages, books, audio series', videos, weather data, sports data, financial data, blog posts) from a plurality of content sources, and deliver updated content over time to computing device 102. For example, content search engine 1052 may be configured to retrieve content items from a plurality of content providers (e.g., digital news publishers, various websites, social media posts) and store the content items in content storage 1054. Content classifier 1056 may be configured to classify and/or categorize content stored in content storage 1054 with respect to, for example, topics, popularity, trending status, target demographic, geographic location, and temporal freshness. Content selector 1058 may be configured to identify one or more content items that are relevant to one or more user accounts, by comparing or matching account profile data 1060 and the classification information associated with a content item. For example, in addition to account credentials information (e.g., user identifiers (IDs) and passwords), account profile data 1060 may include explicit or implied content preferences for a user, or a group of users, associated with an account (e.g., preferences input by a user via a configuration menu, preferences derived from user activity in applications, browsing history). Although feeds service server 1050 is shown in a cloud computing environment relative to computing device 102 (e.g., a client), the functionality described with respect to feeds service server 1050 may be executed on computing device 102 (where the content cards are to be displayed), in the cloud (e.g., feeds service server 1050), or partially locally and partially in the cloud. Content selector 1058 may be configured to select one or more categorized content items for a particular content feed (e.g., a news feed) to be displayed in dashboard panel view 1022 on computing device 102.

In some embodiments, dashboard panel application 118 may be configured to cause the rendering of an interactive menu for personalizing a content feed (e.g., a news feed). The menu may be provided as an in-line card with other content cards in scrollable arrangement 1024, or as a pop-up menu, for example. In this regard, a user may select controls displayed in the menu card that define which topics a user would like to receive in their news feed (e.g., movies, travel, technology, food, gaming, streaming). The user's selections may be associated with their account(s) and utilized by content selector 1058 to filter content for their news feed. Alternatively, or in addition, for some content feeds, content selector 1058 may select a default set of content items (e.g., rather than content customized for a particular user or group account).

Once account credentials are authenticated for a user, dashboard panel application 118 may be configured to automatically retrieve newly published and/or updated content over time from feeds service server 1050 via network 108 for the user. For each content item selected for a content feed, feeds service server 1050 may provide a subset of the content item or a reduced volume of content that represents the content item (e.g., news headlines, text summaries, quotes, representative photographs, graphics) and/or related information (e.g., authors, content sources) in a feed content component to computing device 102. Dashboard panel application 118 may be configured to cause content received in a feed to be rendered into one or more respective content elements (e.g., content cards) in scrollable arrangement 1024, in dashboard panel 122. For example, the content cards may comprise first content card 1026A through Nth content card 1026N. The content cards may be referred to as content feed cards, view frames, or news cards, for example. Each displayed content card may include a subset of a respective content item, or information related to the respective content item, received from feeds service server 1050 or from an original content source (e.g., a website). A content card may comprise interactive elements (e.g., click targets) that provide a navigation link to the full respective content item (e.g., at the feeds service server 1050 or at another resource such as a website where the respective content item may have been originally accessed). For example, an entire content card may comprise a click target. A plurality of content cards may be displayed in dashboard panel 1022 and may be scrollable. For example, a plurality of content cards (e.g., content cards 1026A-1026N) may be arranged in scrollable arrangement 1024 of dashboard panel view 1022, and a user may interact with the scrollable arrangement to scroll through the cards (e.g., swipe up/down or left/right in a touch screen, turn a mouse wheel, click and/or drag a scroll bar, use a keypad direction key such as up, down, left, or right keys, input a voice command via a microphone).

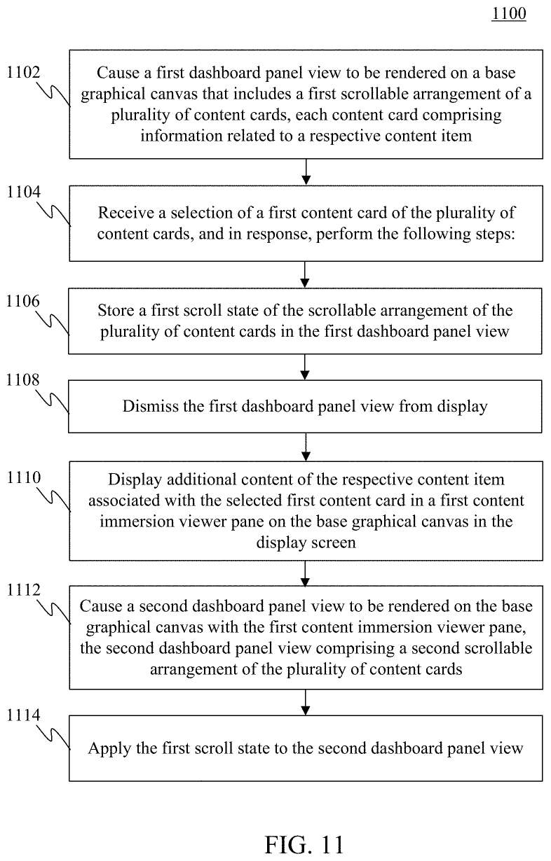

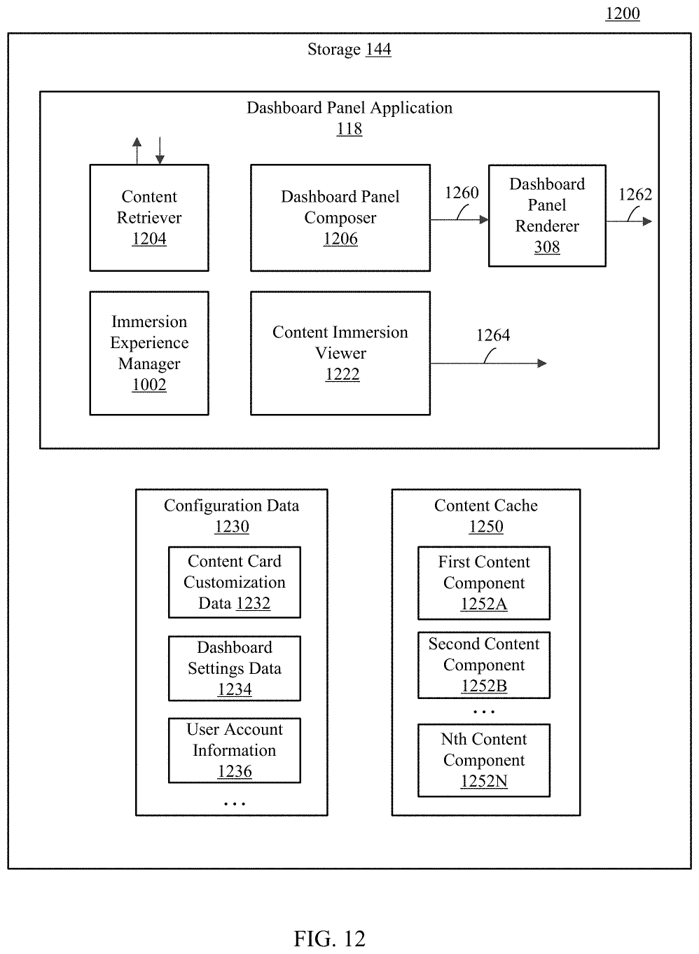

Dashboard panel application 118 of FIG. 10 may be configured in various ways and may operate in various ways, to perform these and further functions. For instance, FIG. 11 shows a flowchart 1100 of a method in a computing device for rendering a flow of dashboard panel views in an immersion experience comprising scrollable content cards and a selectable expanded view, according to an example embodiment. Flowchart 1100 may be implemented by dashboard panel application 118, dashboard panel renderer 308, immersion experience manager 1002, and content immersion viewer 1222. For purposes of illustration, flowchart 1100 is described with reference to FIGS. 10 and 12. FIG. 12 shows a block diagram of a system 1200 for rendering a flow of dashboard panel views in an immersion experience comprising scrollable content cards and a selectable expanded view, according to an example embodiment.

As shown in FIG. 12, storage 144 stores dashboard panel application 118, configuration data 1230, and a content cache 1250. Dashboard panel application 118 includes a content retriever 1204, immersion experience manager 1002, a dashboard panel composer 1206, a content immersion viewer 1222, and dashboard panel renderer 308. Configuration data 1230 comprises content card customization data 1232, dashboard settings data 1234, and user account information 1236. Content cache 1250 may store a first content component 1252A and a second content component 1252B through an Nth content component 1252B (i.e., content components 1252A-1252N).

Processor(s) 106 may be configured to execute dashboard panel application 118, for example, upon initiation by a user. Content retriever 1204 may be configured to log into feeds service server 1050 utilizing credentials entered by a user, or stored in user account information 1236 (e.g., credentials utilized to log into OS 116 or selected from an account manager). Content retriever 1204 may access a content feed from feeds service server 1050, which may comprise a plurality of feed content components (as described above with respect to FIG. 10). Content retriever 1204 may store the feed content components in content cache 1250 and/or another storage area as one or more of content components 1252A-1252N, and may retrieve and store updated or new feed content components over time (e.g., periodically) while dashboard panel application 118 is running. In some embodiments, content retriever 1204 may access other types of content components (e.g., from local or remote applications or websites) and may also store the content in content cache 1250 as one or more of content components 1252A-1252N. For example, in addition to retrieving content components from feeds service server 1050, content retriever 1204 may be configured to aggregate local content or content retrieved from websites via network 108 for the content cards. In this regard, the selection of content components for content cards may be based on user preferences stored in user account information 1236 (e.g., topics of interest such as movies, travel, technology, food, gaming, streaming).

Flowchart 1100 of FIG. 11 begins with step 1102. In step 1102, a first dashboard panel view is caused to be rendered on the base graphical canvas, which includes a first scrollable arrangement of a plurality of content cards, where each content card comprises information related to a respective content item. As described below, dashboard panel composer 1206 may be configured to compose one or more styles of content cards 1026 and one or more styles of scrollable content card arrangements 1024 for display in dashboard panel view 1022 (e.g., different size or shape cards, a vertical column of cards, a horizontal row of cards, a cascade of cards, and/or other arrangements of cards). The plurality of content cards 1026A-1026N may comprise one or more of feed content cards, widgets, and/or cards representing content from other applications (e.g., information from a local or remote application such as a calendar application). As described above, the content included in each content card 1026A-1026N may comprise a subset of a respective content item, or information related to the respective content item from an original source (e.g., a website, feeds service server, application).

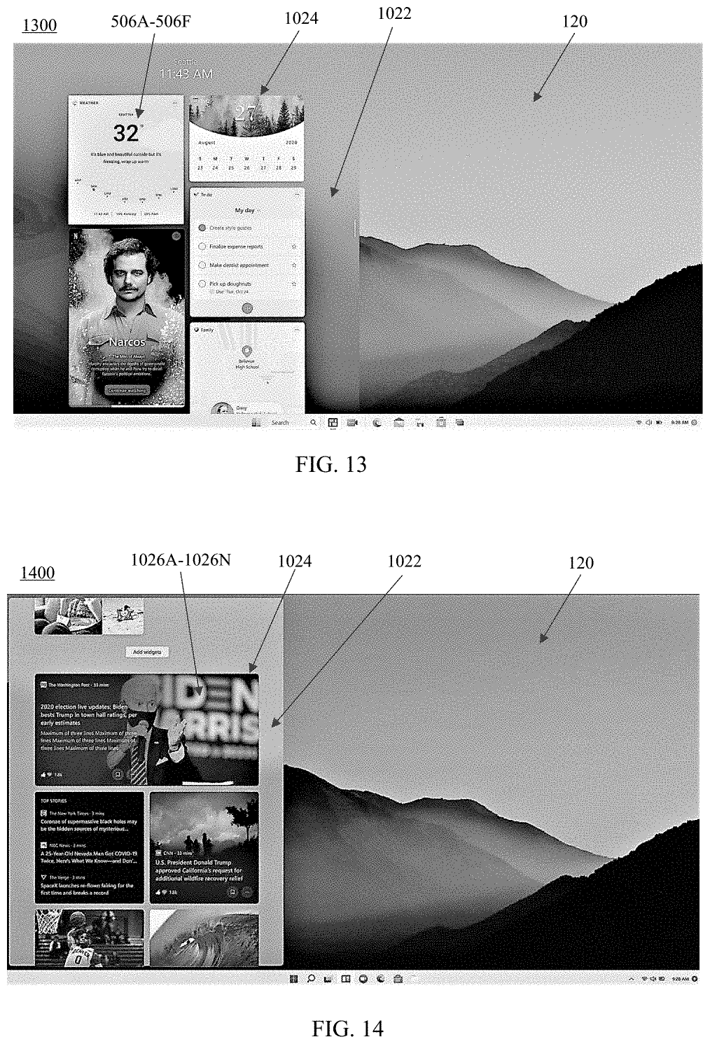

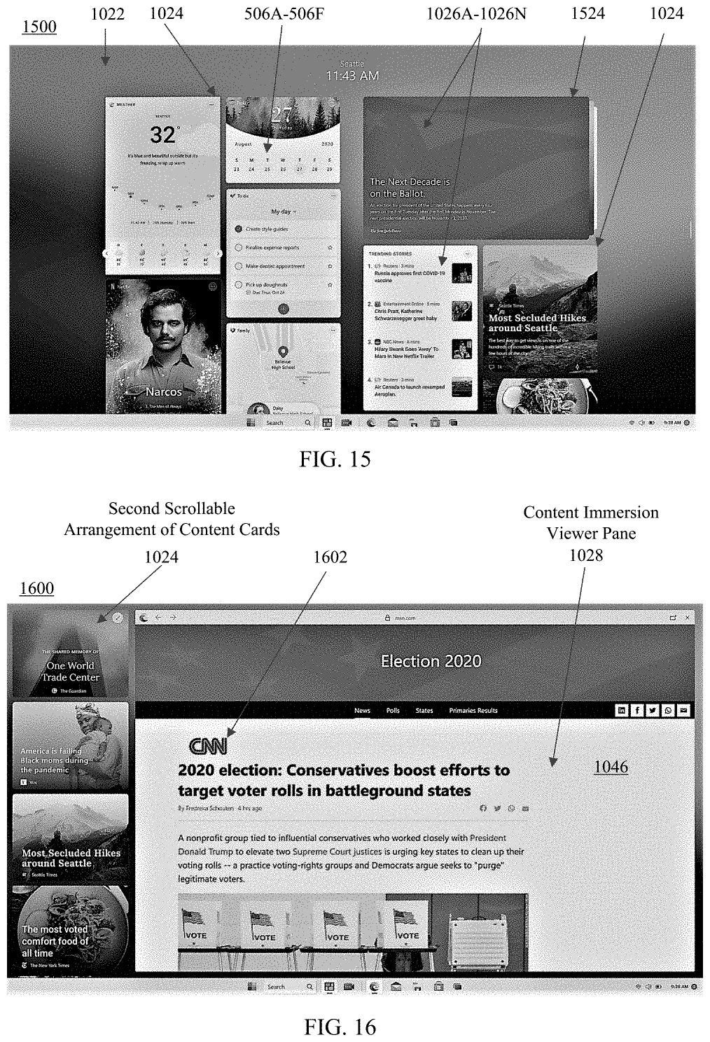

Dashboard panel composer 1206 may be configured to access and/or select one or more cached content card components 1252A-1252N and may access content card customization data 1232 and/or dashboard settings data 1234 for composing dashboard panel view 1022 comprising scrollable arrangement 1024. Content card customization data 1232 may comprise parameters for design features of content cards (e.g., shapes, sizes, borders, focus). Dashboard settings 1234 that may comprise design parameters for configuring scrollable arrangement 1024 (e.g., screen position of the scrollable arrangement 1024, orientation of the scrollable arrangement, a side-by-side pattern of cards in the scrollable arrangement, a cascaded pattern of cards in the scrollable arrangement, theme (e.g., light, dark) for the scrollable arrangement). Dashboard settings 1234 may also include parameters for determining what kinds of cards will be included in dashboard panel view 1022 (e.g., content cards, feed content cards, widgets) (see FIGS. 13-15). In one embodiment, dashboard panel application 118 may be configured to compose scrollable arrangement 1024 with rectangular content cards arranged in two columns, where the arrangement is positioned on a left side or right side of graphical canvas 120. Similarly, a view of rendered widgets 506A-506F may be positioned next to scrollable arrangement 1024 in dashboard panel view 1022 (see FIG. 15). Each content card may comprise one or more controls so that a user may interact with the card (e.g., card selection controls or navigation links to a respective content item such as at feeds service server 1050 or another resource from which a respective content item may have been originally resourced). Dashboard panel composer 1206 may be configured to compose a document that describes a view of each content card for rendering. For example, dashboard panel composer 1206 may generate a dashboard panel view 1022 comprising an XML document, an HTML document, or other format document that contains DOM code descriptive of dashboard panel view1022 for rendering.

Dashboard panel renderer 308 may comprise a rendering engine that may be configured to render the DOM code into dashboard panel view 1022 comprising scrollable arrangement 1024. For example, dashboard panel renderer 308 may receive a dashboard panel view 1260 (e.g., in document form), and render dashboard panel view 1260 into dashboard panel view 1262 (e.g., in the form of pixel data). Dashboard panel view 1022 may be displayed based upon dashboard panel view 1262 and may include rendered views of scrollable arrangement 1024 comprising at least a portion of the content cards 1026A-1026N. In some, embodiments, not all of content cards 1026A-1026N may fit on display screen 110 together. For example, at any one time, some of the content cards may not be visible but may be surfaced or rotated in scrollable arrangement 1024, e.g., as a result of user scrolling input (described above). As described above, dashboard panel renderer 308 may include a rendering engine similar to that of a web browser but without full browser functionality. The rendering engine may be configured to perform page layout and rendering of content within each content card view frame of the scrollable arrangement 1024.

In step 1104, a selection of a first content card of the plurality of content cards is received, and in response, the following steps are performed. For example, a user may interact with a control element within a particular card of the content cards 1026A-1026N (e.g., via a mouse click, a touch input, a cursor hover, a voice input via a microphone). The control element may comprise a navigation link to a content provider (e.g., feeds service server 1050, a website, or another resource) that provides access to the respective content item related to the selected content card.

In step 1106, a first scroll state of the scrollable arrangement of the plurality of content cards in the first dashboard panel view is stored. For example, in response to detecting the user interaction with (e.g., selection of) the first content card, immersion experience manager 1002 may be configured to store the state of scrollable arrangement 1024 of dashboard panel view 1022. For example, in one embodiment, immersion experience manager 1002 may be configured to record which components of content components 1252A-1252N and which parameters (e.g., content card customization data 1232 and/or dashboard settings data 1234) were utilized to compose the content cards of the current scrollable arrangement 1024. Also, immersion experience manager 1002 may be configured to store the current scroll state of the content cards (e.g., which content cards 1026A-1026N were visible in dashboard panel view 1022 when the user interaction input was received).

In step 1108, the first dashboard panel view is dismissed from display. For example, further in response to detecting the user interaction with the particular content card, immersion experience manager 1002 may be configured to begin controlling the processes of reflowing the first dashboard panel view 1022 to present an immersion experience. The immersion experience may comprise display of the additional or expanded content, which is related to the selected particular content card, in content immersion viewer pane 1028 along with (e.g., side by side with) a second version of the scrollable arrangement 1024. The second version of scrollable arrangement 1024 may be modified in size and/or position to accommodate display of the content immersion viewer pane 1028 within a second dashboard panel view 1022. Dashboard panel application 118 may be configured to discontinue display of the first version of dashboard panel view 1022. However, a user may not perceive a blank screen during the transition from the first displayed dashboard panel view 1022 to a second displayed dashboard panel view 1022 as the first displayed view may be maintained until the next view is displayed, or other effects may be displayed for the transition between views.

In step 1110, additional content of the respective content item associated with the selected first content card may be displayed in a first content immersion viewer pane on the base graphical canvas in the display screen. For example, immersion experience manager 1002 may be configured to control content retriever 1204 to navigate via network 108 to a content provider, and access a respective content item (additional or expanded content) corresponding to the content component 1252 of the selected content card (e.g., utilizing a network address (e.g., a URL) interacted with in the content card). The respective content item may be retrieved from feeds service server 1050 or another content resource that stores the respective content item (e.g., a website or other server). Immersion experience manager 1002 may control content immersion viewer 1222 to compose and render content immersion pane 1028 on base graphical canvas 120. Content immersion pane 1028 may comprise additional content view 1046 of the respective content item (e.g., a full article, images, video, audio) related to the selected content card. For example, if a news headline was displayed in the selected content card, the corresponding additional content view 1046 may display the full news corresponding to the news headline.

Content immersion viewer 1222 may comprise, for example, a web viewer, video viewer, photo viewer, and/or graphics viewer that may be configured to allow a user to view and interact with the respective content item, but may not include all the features of a full web browser, such as an address bar, a search bar, specialized navigation buttons, etc. Content immersion viewer 1222 may be implemented in various ways. For example, content immersion viewer 1222 may be integrated or embedded inside dashboard panel application 118. Alternatively, or in addition, content immersion viewer 1222 or a portion of the viewer (e.g., a subset of functions of the viewer) may be implemented as a separate or stand-alone application(s) running in computing device 102. Moreover, in some embodiments, dashboard panel composer 1206 and/or dashboard panel renderer 308 may perform some or all of the functions of content immersion viewer 1222.

In step 1112, a second dashboard panel view may be rendered on the base graphical canvas with the first content immersion viewer pane. The second dashboard panel view may comprise a second scrollable arrangement of the plurality of content cards. For example, immersion experience manager 1002 may be configured to control dashboard panel application 118 to compose a second version of scrollable arrangement 1024. Dashboard panel application 118 may be configured to retrieve the stored scroll state which may indicate which of content components 1252A-1252N and which parameters (e.g., content card customization data 1232 and/or dashboard settings data 1234) were utilized to compose the content cards of the prior scrollable arrangement 1024. Dashboard panel application 118 may be configured to utilize the retrieved parameters and/or additional parameters to compose a second dashboard panel view 1260 (e.g., in document form), that is composed to be positioned along with (e.g., side by side with) content immersion viewer pane 1028. The second dashboard panel view 1260, which may be modified in size, shape, orientation, or other aspects relative to the first (prior) dashboard panel view 1260 based on configuration data 1230. Dashboard panel renderer 308 may be configured to receive second dashboard panel view 1260 and render second dashboard panel view 1260 into a second dashboard panel view 1262 (e.g., in the form of pixel data). A second dashboard panel view 1022 may be displayed based upon pixel data of second dashboard panel view 1262 and may include a rendered view of the second version of the scrollable arrangement 1024.

In step 1114, the first scroll state may be applied to the second dashboard panel view. For example, the second version of the scrollable arrangement of content cards 1024 may comprise at least a portion content cards 1026A-1026N, where at any one time, some of the content cards may not be visible on display screen 110, but may be surfaced in scrollable arrangement 1024 as a result of a user's scrolling input (as described above). At the time when the user selected or interacted with a content card in the first (prior) version of scrollable arrangement 1024, content cards 1026A-1026N may have been displayed in a particular position and/or order. By storing the scroll state, the context of scrollable content cards (e.g., including position and/or order) was preserved and may be restored in the second version of scrollable arrangement 1024 by applying the stored parameters of the scroll state.

Scrollable arrangements 1024 may be displayed in various ways. For example, FIGS. 13-15 illustrate example displays 1300, 1400, and 1500 of scrollable arrangements 1024 of content cards prior to entering an immersion experience view, according to example embodiments. For example, FIG. 13 includes a display 1300 comprising a scrollable arrangement of widgets 506A-506F that are rendered in dashboard panel view 1022 on base graphical canvas 120. Dashboard panel view 1022 may comprise a header that may include various information such as a greeting “good morning” and the current time. Dashboard panel view 1022 comprising scrollable arrangement 1024 may be launched in various ways. For example, user may select (e.g., click upon) a task bar icon or may use a touch input gesture to drag the dashboard open from the side of graphical base canvas 120.

FIG. 14 includes a display 1400 comprising a scrollable arrangement 1024 of content feed cards 1026A-1026N that are rendered in dashboard panel view 1022 on base graphical canvas 120. As described above dashboard panel view 1022 may comprise a header and may be launched in various ways (e.g., by selecting a task bar icon or a touch input gesture to drag the dashboard open from the side of graphical base canvas 120).

FIG. 15 includes a display 1500 comprising two scrollable arrangements with widgets 506A-506F on one side and content feed cards 1026A-1026N on the second side (e.g., left and right sides, respectively) of dashboard panel view 1022. The two scrollable arrangements may be launched in various ways. In one example, a scrollable arrangement comprising widgets 506A-506F may be launched on one side of graphical base canvas 120 (e.g., the left side) and a scrollable arrangement 1024 of content cards 1026A-1026N may be launched by dragging a side drawer (not shown) out from the scrollable arrangement comprising widgets 506A-506F, for example, using a touch and drag gesture. Also shown in system 1500 are content cards of plurality of content cards 1026A-1026N that are displayed in a cascade view 1524 comprising a fanned stack of content cards within the scrollable arrangement 1024. Content cards in cascade view 1524 may be scrolled though as a result of user input such as a click and drag, a voice command, or a touch screen gesture such as a drag or flick within the top content card in the stack. In some embodiments, immersion experience manager 1002 may be configured to automatically scroll through content cards in a scrollable arrangement 1024 (e.g., content cards displayed in a cascade view or in a side-by-side flat pattern view may be automatically scrolled through). In one example, immersion experience manager 1002 may be configured to cycle through the available content cards based on a time interval, which may bring a user's attention to new content. Although the scrollable arrangements 1024 shown in FIGS. 13-15 comprise either widgets or other types of content cards such as feed content cards, the disclosure is not limited in this regard, and in some embodiments, a single scrollable arrangement 1024 may comprise multiple types of content cards such as a combination of widgets, feed content cards, application content cards, etc.

FIG. 16 comprises a display 1600 that illustrates an example content immersion experience display comprising a second dashboard panel view including a second scrollable arrangement of a plurality of content cards and a first content immersion viewer pane, according to an example embodiment. For example, system 1600 shows an example display generated as a result of performing steps 1102-1114 of flow chart 1100. In response to a user selection or interaction with a control element (e.g., a navigation link, or any point in the area of the content card) in a displayed content card (e.g., a feeds content card) of the plurality of content cards 1026A-1026N in a first scrollable arrangement 1024, immersion experience manager 1002 may save the current scroll state and control content retriever 1204 to retrieve a respective content item related to the selected content card (e.g., from feeds service server 1050 or another content resource corresponding to the navigation link). The first dashboard panel view 1022 comprising the first scrollable arrangement 1024 may be dismissed. Immersion experience manager 1002 may control content immersion viewer 1222 to compose and render the respective content item in content immersion viewer pane 1028 as additional content view 1046 of the respective content item (e.g., as a full news article) related to the selected content card. Moreover, immersion experience manager 1002 may be configured to control dashboard panel application 118 to compose a second version of scrollable arrangement 1024 in a second dashboard panel view 1022, which may be rendered next to content immersion viewer pane 1028. The second scrollable arrangement may be modified in size, shape, orientation, or other aspects relative to the first scrollable arrangement 1024 to accommodate display of the additional content view 1046, which may have greater dimensions than a content card. The context of the user's scrolling activity in the first scrollable arrangement 1024 prior to selection of the content card may be preserved by applying the stored scroll state. Each of the second dashboard panel view 1022 with second scrollable arrangement 1024 and the first content immersion viewer pane with additional content view 1046 may be scrolled independently in response to user input.

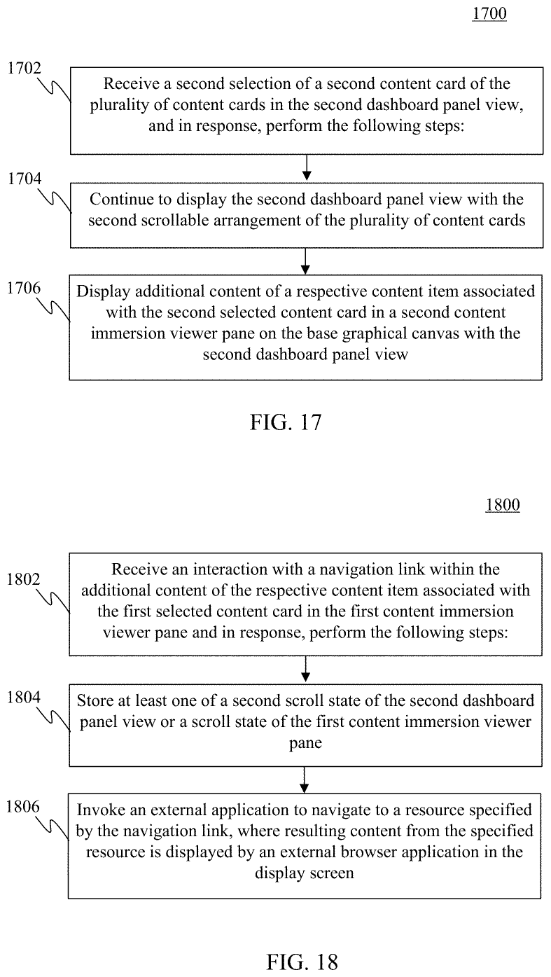

Immersion experience manager 1002 of FIG. 10 may be configured in various ways and may operate in various ways, to perform these and further functions. For instance, FIG. 17 shows a flowchart 1700 of a method for responding to a second selection of a content card in a second scrollable arrangement 1024 while a first content immersion pane is being displayed, according to an example embodiment. Flowchart 1700 may be implemented by immersion experience manager 1002 and content immersion viewer 1222. For purposes of illustration, flowchart 1700 is described with reference to FIGS. 10, 12, and 16.

Flowchart 1700 of FIG. 17 begins with step 1702. In step 1702, a second selection of a second content card of the plurality of content cards in the second dashboard panel view is received, and in response, the following steps are performed. For example, a user selection or interaction with a second content card (e.g., at a navigation link, or any point in the area of the content card) of the plurality of content cards 1026A-1026N in the second scrollable arrangement 1024 may be received.

In step 1704, the second dashboard panel view with the second scrollable arrangement of the plurality of content cards may continue to be displayed. For example, dashboard panel application 118 may continue to display second scrollable arrangement 1024 and may maintain and update the scrollable state of second scrollable arrangement 1024 according to user input (e.g., content card scrolling input) in content cards of the second scrollable arrangement 1024.

In step 1706, additional content of a respective content item associated with the second selected content card in may be displayed in a second content immersion viewer pane on the base graphical canvas with the second dashboard panel view. For example, immersion experience manager 1002 may control content retriever 1204 to retrieve a second respective content item related to the second selected content card (e.g., from feeds service server 1050 or another content resource indicated by the interacted with navigation link). Immersion experience manager 1002 may control content immersion viewer 1222 to compose and render the second respective content item in a second content immersion viewer pane 1028 on the base graphical canvas 120, as second additional content view 1046 of the respective second content item (e.g., as a second full news article) related to the second selected content card. The second content immersion viewer pane 1028 may be displayed in a second tab relative to a first tab comprising the first content immersion viewer pane 1028, or the first content immersion viewer pane 1028 may be dismissed before the second content immersion viewer pane 1028 is displayed.

Immersion experience manager 1002 of FIG. 10 may be configured in various ways and may operate in various ways, to perform these and further functions. For instance, FIG. 18 shows a flowchart 1800 of a method for responding to a user interaction with a navigation link within a first content immersion pane, according to an example embodiment. Flowchart 1800 may be implemented by immersion experience manager 1002 and a web browser. For purposes of illustration, flowchart 1800 is described with reference to FIGS. 10, 12, and 16.

Flowchart 1800 of FIG. 18 begins with step 1802. In step 1802, an interaction with a navigation link within the additional content of the respective content item associated with the first selected content card in the first content immersion viewer pane is received, and in response, the following steps are performed. For example, as shown in FIG. 16, additional content view 1046 in content immersion viewer pane 1028 comprises a navigation link 1602 that a user may interact with to navigate to a website (e.g., a network address or URL to navigate to a website such as the CNN website).

In step 1804, at least one of a second scroll state of the second dashboard panel view or a scroll state of the first content immersion viewer pane is stored. For example, immersion experience manager 1002 may store a second scroll state of second scrollable arrangement 1024 and/or a scroll state of first immersion viewer pane 1028 to preserve the context of the user's experience in display screen 110. For example, information such as a scroll position, content card customization data 1232, dashboard settings data 1234 pertaining to the second scrollable arrangement 1024 at or about the time of the interaction with the navigation link interaction, may be stored for a potential later application.

In step 1806, an external application may be invoked to navigate to a resource specified by the navigation link, where resulting content from the specified resource is displayed by the external application in the display screen. For example, in response to a user interaction with navigation link 1602 (e.g., network address or URL), immersion experience manager 1002 may be configured to invoke an external application (e.g., web browser application 1070 of FIG. 10). Web browser application 1070 may be configured to navigate to the network address and display a webpage from the website at the network address in a browser interface in display screen 110. In some embodiments, second scrollable arrangement 1024 and content immersion viewer pane 1028 may be dismissed while the browser interface is displayed.

In some embodiments, if a user interaction is received that causes a return from the external application (e.g., web browser application 1070 is closed), immersion experience manager 1002 may be configured to control dashboard panel application 118 to render a third dashboard panel view 1022 comprising a third scrollable arrangement 1024 of the plurality of content cards 1026A-1026N on the base graphical canvas 120 in display screen 110, and may control content immersion viewer 1222 to render a second content immersion viewer pane 1020 comprising second additional content view 1046. Any previously stored scroll state of the second scroll state of the second dashboard panel view 1022 or a scroll state of the first content immersion viewer pane 1028, may be applied to the third dashboard panel view 1022 or the second content immersion viewer pane 1028. In some embodiments, the stored scroll state(s) may expire after a specified period of time. If the stored scroll state(s) expire before a user closes the external application, dashboard panel application 118 may be configured to display the first scrollable arrangement 1024 or a default scrollable arrangement 1024 after the user closes the external application (web browser 1070).

In another embodiment, second scrollable arrangement 1024 may continue to be displayed side by side with the browser interface displaying the navigated webpage.

### IV. Example Mobile and Stationary Device Embodiments

The systems and methods described above with reference to FIGS. 1-18, may be implemented in hardware, or hardware combined with one or both of software and/or firmware. For example, dashboard panel application 118, service data retriever 304, dashboard panel composer 306, dashboard panel renderer 308, widget configurer 310, widget selector 312, immersion experience manager 1002, web browser application 1070, dashboard panel composer 1206, content immersion viewer 1222 and flowcharts 200, 700, 800, 900, 1100, 1700, and/or 1800 may be each implemented as computer program code/instructions configured to be executed in one or more processors and stored in a computer readable storage medium. Alternatively, dashboard panel application 118, service data retriever 304, dashboard panel composer 306, dashboard panel renderer 308, widget configurer 310, widget selector 312, immersion experience manager 1002, web browser application 1070, dashboard panel composer 1206, content immersion viewer 1222 and flowcharts 200, 700, 800, 900, 1100, 1700, and/or 1800 may be implemented as hardware logic/electrical circuitry. In an embodiment, dashboard panel application 118, service data retriever 304, dashboard panel composer 306, dashboard panel renderer 308, widget configurer 310, widget selector 312, immersion experience manager 1002, web browser application 1070, dashboard panel composer 1206, content immersion viewer 1222 and flowcharts 200, 700, 800, 900, 1100, 1700, and/or 1800 may be implemented in one or more SoCs (system on chip). An SoC may include an integrated circuit chip that includes one or more of a processor (e.g., a central processing unit (CPU), microcontroller, microprocessor, digital signal processor (DSP)), memory, one or more communication interfaces, and/or further circuits, and may optionally execute received program code and/or include embedded firmware to perform functions.

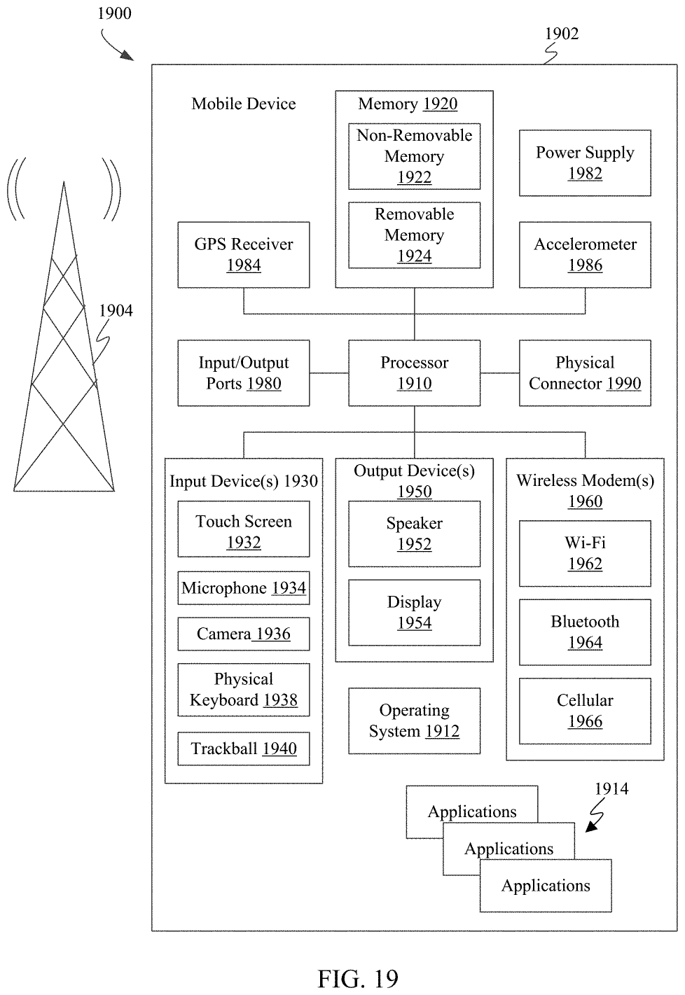

FIG. 19 shows a block diagram of an exemplary mobile device 1900 including a variety of optional hardware and software components, shown generally as components 1902. In an embodiment, computing device 102 may be implemented as mobile device 1900. It is noted that any of components 1902 can communicate with any other of components 1902, although not all connections are shown, for ease of illustration. Mobile device 1900 can be any of a variety of mobile devices described or mentioned elsewhere herein or otherwise known (e.g., cell phone, smartphone, handheld computer, Personal Digital Assistant (PDA)) and can allow wireless two-way communications with one or more mobile devices over one or more communications networks 1904, such as a cellular or satellite network, or with a local area or wide area network.

The illustrated mobile device 1900 can include a controller or processor referred to as processor circuit 1910 for performing such tasks as signal coding, image processing, data processing, input/output processing, power control, and/or other functions. Processor circuit 1910 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 1910 may execute program code stored in a computer readable medium, such as program code of one or more applications 1914, operating system 1912, any program code stored in memory 1920, etc. Operating system 1912 can control the allocation and usage of the components 1902 and support for one or more application programs 1914 (a.k.a. applications, “apps”). Application programs 1914 can include common mobile computing applications (e.g., email applications, calendars, contact managers, web browsers, messaging applications) and any other computing applications (e.g., word processing applications, mapping applications, media player applications).

As illustrated, mobile device 1900 can include memory 1920. Memory 1920 can include non-removable memory 1922 and/or removable memory 1924. The non-removable memory 1922 can include RAM, ROM, flash memory, a hard disk, or other well-known memory storage technologies. The removable memory 1924 can include flash memory or a Subscriber Identity Module (SIM) card, which is well known in GSM communication systems, or other well-known memory storage technologies, such as “smart cards.” The memory 1920 can be used for storing data and/or code for running operating system 1912 and applications 1914. Example data can include web pages, text, images, sound files, video data, or other data sets to be sent to and/or received from one or more network servers or other devices via one or more wired or wireless networks. Memory 1920 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

A number of programs may be stored in memory 1920. These programs include operating system 1912, one or more application programs 1914, and other program modules and program data. Examples of such application programs or program modules may include, for example, computer program logic (e.g., computer program code or instructions) for implementing the systems described above, including the embodiments described with reference to FIGS. 1-18.

Mobile device 1900 can support one or more input devices 1930, such as a touch screen 1932, microphone 1934, camera 1936, physical keyboard 1938 and/or trackball 1940 and one or more output devices 1950, such as a speaker 1952 and a display 1954.

Other possible output devices (not shown) can include piezoelectric or other haptic output devices. Some devices can serve more than one input/output function. For example, touch screen 1932 and display 1954 can be combined in a single input/output device. The input devices 1930 can include a Natural User Interface (NUI).

Wireless modem(s) 1960 can be coupled to antenna(s) (not shown) and can support two-way communications between processor circuit 1910 and external devices, as is well understood in the art. The modem(s) 1960 are shown generically and can include a cellular modem 1966 for communicating with the mobile communication network 1904 and/or other radio-based modems (e.g., Bluetooth 1964 and/or Wi-Fi 1962). Cellular modem 1966 may be configured to enable phone calls (and optionally transmit data) according to any suitable communication standard or technology, such as GSM, 3G, 4G, 5G, etc. At least one of the wireless modem(s) 1960 is typically configured for communication with one or more cellular networks, such as a GSM network for data and voice communications within a single cellular network, between cellular networks, or between the mobile device and a public switched telephone network (PSTN).

Mobile device 1900 can further include at least one input/output port 1980, a power supply 1982, a satellite navigation system receiver 1984, such as a Global Positioning System (GPS) receiver, an accelerometer 1986, and/or a physical connector 1990, which can be a USB port, IEEE 1394 (FireWire) port, and/or RS-232 port. The illustrated components 1902 are not required or all-inclusive, as any components can be not present and other components can be additionally present as would be recognized by one skilled in the art.

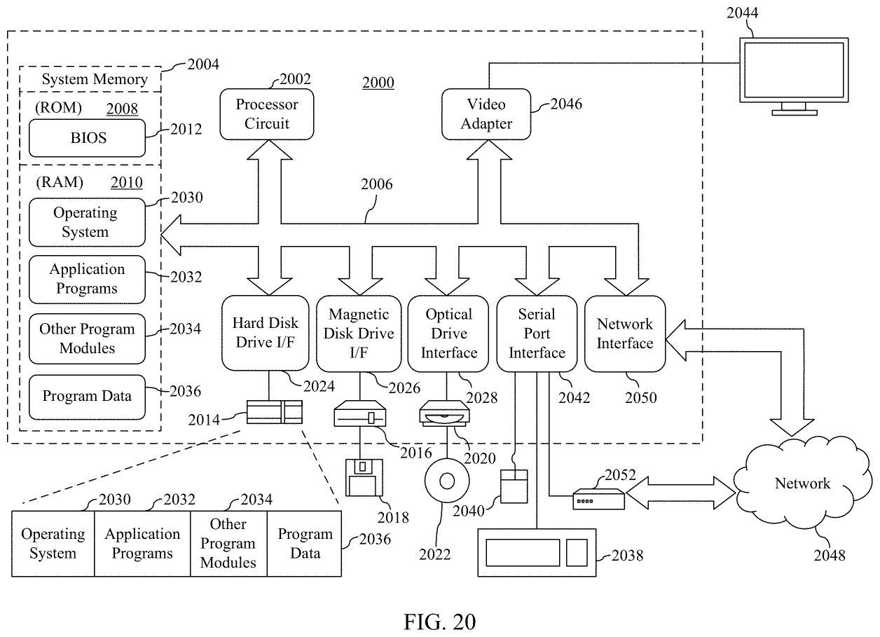

Furthermore, FIG. 20 depicts an exemplary implementation of a computing device 2000 in which embodiments may be implemented. For example, computing device 102, and/or any of servers 104A-104C and 1050 may be implemented as computing device 2000. The description of computing device 2000 provided herein is provided for purposes of illustration, and is not intended to be limiting. Embodiments may be implemented in further types of computer systems, as would be known to persons skilled in the relevant art(s).

As shown in FIG. 20, computing device 2000 includes one or more processors, referred to as processor circuit 2002, a system memory 2004, and a bus 2006 that couples various system components including system memory 2004 to processor circuit 2002. Processor circuit 2002 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 2002 may execute program code stored in a computer readable medium, such as program code of operating system 2030, application programs 2032, other programs 2034, etc. Bus 2006 represents one or more of any of several types of bus structures, including a memory bus or memory controller, a peripheral bus, an accelerated graphics port, and a processor or local bus using any of a variety of bus architectures. System memory 2004 includes read only memory (ROM) 2008 and random access memory (RAM) 2010. A basic input/output system 2012 (BIOS) is stored in ROM 2008.

Computing device 2000 also has one or more of the following drives: a hard disk drive 2014 for reading from and writing to a hard disk, a magnetic disk drive 2016 for reading from or writing to a removable magnetic disk 2018, and an optical disk drive 2020 for reading from or writing to a removable optical disk 2022 such as a CD ROM, DVD ROM, or other optical media. Hard disk drive 2014, magnetic disk drive 2016, and optical disk drive 2020 are connected to bus 2006 by a hard disk drive interface 2024, a magnetic disk drive interface 2026, and an optical drive interface 2028, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 2030, one or more application programs 2032, other programs 2034, and program data 2036. Application programs 2032 or other programs 2034 may include, for example, computer program logic (e.g., computer program code or instructions) for implementing the systems described above, including the embodiments described above with reference to FIGS. 1-18.

A user may enter commands and information into the computing device 2000 through input devices such as keyboard 2038 and pointing device 2040. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 2002 through a serial port interface 2042 that is coupled to bus 2006, but may be connected by other interfaces, such as a parallel port, game port, or a universal serial bus (USB).

A display screen 2044 is also connected to bus 2006 via an interface, such as a video adapter 2046. Display screen 2044 may be external to, or incorporated in computing device 2000. Display screen 2044 may display information, as well as being a user interface for receiving user commands and/or other information (e.g., by touch, finger gestures, a virtual keyboard, by providing a tap input (where a user lightly presses and quickly releases display screen 2044), by providing a “touch-and-hold” input (where a user touches and holds his finger (or touch instrument) on display screen 2044 for a predetermined period of time), by providing touch input that exceeds a predetermined pressure threshold). In addition to display screen 2044, computing device 2000 may include other peripheral output devices (not shown) such as speakers and printers.

Computing device 2000 is connected to a network 2048 (e.g., the Internet) through an adaptor or network interface 2050, a modem 2052, or other means for establishing communications over the network. Modem 2052, which may be internal or external, may be connected to bus 2006 via serial port interface 2042, as shown in FIG. 20, or may be connected to bus 2006 using another interface type, including a parallel interface.

As used herein, the terms “computer program medium,” “computer-readable medium,” and “computer-readable storage medium” are used to generally refer to physical hardware media such as the hard disk associated with hard disk drive 2014, removable magnetic disk 2018, removable optical disk 2022, other physical hardware media such as RAMs, ROMs, flash memory cards, digital video disks, zip disks, MEMs, nanotechnology-based storage devices, and further types of physical/tangible hardware storage media (including system memory 2004 of FIG. 20). Such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media.

As noted above, computer programs and modules (including application programs 2032 and other programs 2034) may be stored on the hard disk, magnetic disk, optical disk, ROM, RAM, or other hardware storage medium. Such computer programs may also be received via network interface 2050, serial port interface 2052, or any other interface type. Such computer programs, when executed or loaded by an application, enable computing device 2000 to implement features of embodiments discussed herein. Accordingly, such computer programs represent controllers of the computing device 2000.

Embodiments are also directed to computer program products comprising computer code or instructions stored on any computer-readable medium. Such computer program products include hard disk drives, optical disk drives, memory device packages, portable memory sticks, memory cards, and other types of physical storage hardware.

### V. Additional Example Embodiments

In one embodiment, a computing device comprises at least one processor circuit, a display that has a display screen, and an operating system (OS) configured to be executed by the at least one processor circuit. The OS is configured to render a base graphical canvas on the display screen. The computing device also comprises at least one memory that stores program code configured to be executed by the at least one processor circuit. The program code is configured to cause a first dashboard panel view to be rendered on the base graphical canvas that includes a first scrollable arrangement of a plurality of content cards. Each content card comprises information related to a respective content item. In response to receiving a selection of a first content card of the plurality of content cards a first scroll state of the scrollable arrangement of the plurality of content cards in the first dashboard panel view is stored. The first dashboard panel view is dismissed from display and additional content of the respective content item associated with the selected first content card in a first content immersion viewer pane is displayed on the base graphical canvas in the display screen. A second dashboard panel view is caused to be rendered on the base graphical canvas with the first content immersion viewer pane. The second dashboard panel view comprises a second scrollable arrangement of the plurality of content cards. The first scroll state is applied to the second dashboard panel view.

In an embodiment of the foregoing computing device, the plurality of content cards comprises at least one of content feed cards or widgets.

In an embodiment of the foregoing computing device, a content immersion viewer that causes the content immersion viewer panes to be rendered is integrated within the program code that causes the dashboard panel views to be rendered.

In an embodiment of the foregoing computing device, the second dashboard panel view is positioned on a first side of the display screen and the first content immersion viewer pane is positioned on a second side of the display screen.

In an embodiment of the foregoing computing device, the second dashboard panel view and the first content immersion viewer pane are each independently scrollable.

In an embodiment of the foregoing computing device, the program code is further configured to, in response to receiving a second selection of a second content card of the plurality of content cards in the second dashboard panel view, continue to display the second dashboard panel view with the scrollable arrangement of the plurality of content cards and display additional content of a respective content item associated with the second selected content card in a second content immersion viewer pane on the base graphical canvas with the second dashboard panel view.

In an embodiment of the foregoing computing device, the program code is further configured to, in response to receiving an interaction with a navigation link in the additional content of the respective content item associated with the first selected content card in the first content immersion viewer pane, store at least one of a second scroll state of the second dashboard panel view or a scroll state of the first content immersion viewer pane and invoke an external application to navigate to a resource specified by the navigation link, where resulting content from the specified resource is displayed by an external browser application in the display screen.

In an embodiment of the foregoing computing device, in response to an interaction that causes a return from the external application, a third dashboard panel view comprising a third scrollable arrangement of the plurality of content cards is caused to be rendered on the base graphical canvas with the first content immersion viewer pane. Any previously stored scroll state of the second scroll state of the second dashboard panel view and the scroll state of the first content immersion viewer pane are applied.

In one embodiment, a method is implemented by a computing device, which includes at least one processor, an operating system (OS) configured to be executed by the at least one processor, and an associated display that has a display screen. The OS is configured to render a base graphical canvas on the display screen. The method comprising causing a first dashboard panel view to be rendered on the base graphical canvas, which includes a first scrollable arrangement of a plurality of content cards, where each content card comprises information related to a respective content item. In response to receiving a selection of a first content card of the plurality of content cards, a first scroll state of the scrollable arrangement of the plurality of content cards in the first dashboard panel view is stored. The first dashboard panel view from display and additional content of the respective content item associated with the selected first content card is displayed in a first content immersion viewer pane on the base graphical canvas in the display screen. A second dashboard panel view is caused to be rendered on the base graphical canvas with the first content immersion viewer pane. The second dashboard panel view comprises a second scrollable arrangement of the plurality of content cards. The first scroll state is applied to the second dashboard panel view.

In an embodiment of the foregoing method, the plurality of content cards comprises at least one of content feed cards or widgets.

In an embodiment of the foregoing method, a content immersion viewer that causes the content immersion viewer panes to be rendered is integrated within the program code that causes the dashboard panel views to be rendered.

In an embodiment of the foregoing method, the second dashboard panel view is positioned on a first side the display screen and the first content immersion viewer pane is positioned on a second side of the display screen.

In an embodiment of the foregoing method, the second dashboard panel view and the first content immersion viewer pane are each independently scrollable.

In an embodiment of the foregoing method, in response to receiving a second selection of a second content card of the plurality of content cards in the second dashboard panel view, continue to display the second dashboard panel view with the scrollable arrangement of the plurality of content cards and display additional content of a respective content item associated with the second selected content card in a second content immersion viewer pane on the base graphical canvas with the second dashboard panel view.

In an embodiment of the foregoing method, in response to receiving an interaction with a navigation link in the additional content of the respective content item associated with the first selected content card in the first content immersion viewer pane, store at least one of a second scroll state of the second dashboard panel view or a scroll state of the first content immersion viewer pane and invoke an external application to navigate to a resource specified by the navigation link. The resulting content from the specified resource is displayed by an external browser application in the display screen.

In an embodiment of the foregoing method, in response to an interaction that causes a return from the external application, a third dashboard panel view comprising a third scrollable arrangement of the plurality of content cards is caused to be rendered on the base graphical canvas with the first content immersion viewer pane and apply any previously stored scroll state of the second scroll state the second dashboard panel view and the scroll state of the first content immersion viewer pane.

In an embodiment, a computer-readable storage medium has program instructions recorded thereon. The program instruction, when executed by one or more processors, perform a method comprising causing a first dashboard panel view to be rendered on the base graphical canvas that includes a first scrollable arrangement of a plurality of content cards. Each content card comprises information related to a respective content item. In response to receiving a selection of a first content card of the plurality of content cards, a first scroll state of the scrollable arrangement of the plurality of content cards in the first dashboard panel view is stored. The first dashboard panel view is dismissed from display. Additional content of the respective content item associated with the selected first content card is displayed in a first content immersion viewer pane on the base graphical canvas in the display screen. A second dashboard panel view is caused to be rendered on the base graphical canvas with the first content immersion viewer pane. The second dashboard panel view comprises a second scrollable arrangement of the plurality of content cards. The first scroll state is applied to the second dashboard panel view.

In an embodiment of the foregoing computer-readable storage medium, the second dashboard panel view is positioned on a first side the display screen and the first content immersion viewer pane is positioned on a second side of the display screen

In an embodiment of the foregoing computer-readable storage medium, the second dashboard panel view and the first content immersion viewer pane are each independently scrollable.

In an embodiment of the foregoing computer-readable storage medium, the method further comprises, in response to receiving a second selection of a second content card of the plurality of content cards in the second dashboard panel view, continue to display the second dashboard panel view with the scrollable arrangement of the plurality of content cards and display additional content of a respective content item associated with the second selected content card in a second content immersion viewer pane on the base graphical canvas with the second dashboard panel view.

### VI. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A computing device, comprising:
at least one processor circuit;
a display that has a display screen;
an operating system (OS) configured to be executed by the at least one processor circuit, the OS configured to render a base graphical canvas on the display screen; and
at least one memory that stores program code configured to be executed by the at least one processor circuit, the program code configured to:
cause a first dashboard panel view to be rendered on the base graphical canvas that includes a first scrollable arrangement of a plurality of content cards, each content card comprising information related to a respective content item;
in response to receiving a selection of a first content card of the plurality of content cards:
store a first scroll state of the scrollable arrangement of the plurality of content cards in the first dashboard panel view;
dismiss the first dashboard panel view from display;
display additional content of the respective content item associated with the selected first content card in a first content immersion viewer pane on the base graphical canvas in the display screen;
cause a second dashboard panel view to be rendered on the base graphical canvas with the first content immersion viewer pane, the second dashboard panel view comprising a second scrollable arrangement of the plurality of content cards; and
apply the first scroll state to the second dashboard panel view.

2. The computing device of claim 1, wherein the plurality of content cards comprises at least one of content feed cards or widgets.

3. The computing device of claim 1, wherein a content immersion viewer that causes the content immersion viewer panes to be rendered is integrated within the program code that causes the dashboard panel views to be rendered.

4. The computing device of claim 1, wherein the second dashboard panel view is positioned on a first side of the display screen and the first content immersion viewer pane is positioned on a second side of the display screen.

5. The computing device of claim 1, wherein the second dashboard panel view and the first content immersion viewer pane are each independently scrollable.

6. The computing device of claim 1, wherein the program code is further configured to:
in response to receiving a second selection of a second content card of the plurality of content cards in the second dashboard panel view:
continue to display the second dashboard panel view with the second scrollable arrangement of the plurality of content cards; and
display additional content of a respective content item associated with the second selected content card in a second content immersion viewer pane on the base graphical canvas with the second dashboard panel view.

7. The computing device of claim 1, wherein the program code is further configured to:
in response to receiving an interaction with a navigation link within the additional content of the respective content item associated with the first selected content card in the first content immersion viewer pane:
store at least one of a second scroll state of the second dashboard panel view or a scroll state of the first content immersion viewer pane; and
invoke an external application to navigate to a resource specified by the navigation link, wherein resulting content from the specified resource is displayed by an external browser application in the display screen.

8. The computing device of claim 7 comprising, in response to an interaction that causes a return from the external application:
cause a third dashboard panel view comprising a third scrollable arrangement of the plurality of content cards to be rendered on the base graphical canvas with the first content immersion viewer pane; and
apply any previously stored scroll state of the second scroll state of the second dashboard panel view and the scroll state of the first content immersion viewer pane.

9. A method implemented by a computing device that includes at least one processor, an operating system (OS) configured to be executed by the at least one processor, and an associated display that has a display screen, the OS configured to render a base graphical canvas on the display screen, the method comprising:
causing a first dashboard panel view to be rendered on the base graphical canvas that includes a first scrollable arrangement of a plurality of content cards, each content card comprising information related to a respective content item;
in response to receiving a selection of a first content card of the plurality of content cards:
storing a first scroll state of the scrollable arrangement of the plurality of content cards in the first dashboard panel view;
dismissing the first dashboard panel view from display;
displaying additional content of the respective content item associated with the selected first content card in a first content immersion viewer pane on the base graphical canvas in the display screen;
causing a second dashboard panel view to be rendered on the base graphical canvas with the first content immersion viewer pane, the second dashboard panel view comprising a second scrollable arrangement of the plurality of content cards; and
applying the first scroll state to the second dashboard panel view.

10. The method of claim 9, wherein the plurality of content cards comprises at least one of content feed cards or widgets.

11. The method of claim 9, wherein a content immersion viewer that causes the content immersion viewer panes to be rendered is integrated within the program code that causes the dashboard panel views to be rendered.

12. The method of claim 9, wherein the second dashboard panel view is positioned on a first side the display screen and the first content immersion viewer pane is positioned on a second side of the display screen.

13. The method of claim 9, wherein the second dashboard panel view and the first content immersion viewer pane are each independently scrollable.

14. The method of claim 9, further comprising:
in response to receiving a second selection of a second content card of the plurality of content cards in the second dashboard panel view:
continuing to display the second dashboard panel view with the second scrollable arrangement of the plurality of content cards; and
displaying additional content of a respective content item associated with the second selected content card in a second content immersion viewer pane on the base graphical canvas with the second dashboard panel view.

15. The method of claim 9, further comprising:
in response to receiving an interaction with a navigation link within the additional content of the respective content item associated with the first selected content card in the first content immersion viewer pane:
storing at least one of a second scroll state of the second dashboard panel view or a scroll state of the first content immersion viewer pane; and
invoking an external application to navigate to a resource specified by the navigation link, wherein resulting content from the specified resource is displayed by an external browser application in the display screen.

16. The method of claim 15 further comprising, in response to an interaction that causes a return from the external application:
causing a third dashboard panel view comprising a third scrollable arrangement of the plurality of content cards to be rendered on the base graphical canvas with the first content immersion viewer pane; and
applying any previously stored scroll state of the second scroll state the second dashboard panel view and the scroll state of the first content immersion viewer pane.

17. A computer-readable storage medium having program instructions recorded thereon that, when executed by one or more processors, perform a method, the method comprising:
causing a first dashboard panel view to be rendered on the base graphical canvas that includes a first scrollable arrangement of a plurality of content cards, each content card comprising information related to a respective content item;
in response to receiving a selection of a first content card of the plurality of content cards:
storing a first scroll state of the scrollable arrangement of the plurality of content cards in the first dashboard panel view;
dismissing the first dashboard panel view from display;
displaying additional content of the respective content item associated with the selected first content card in a first content immersion viewer pane on the base graphical canvas in the display screen;
causing a second dashboard panel view to be rendered on the base graphical canvas with the first content immersion viewer pane, the second dashboard panel view comprising a second scrollable arrangement of the plurality of content cards; and
applying the first scroll state to the second dashboard panel view.

18. The computer-readable storage medium of claim 17, wherein the second dashboard panel view is positioned on a first side the display screen and the first content immersion viewer pane is positioned on a second side of the display screen.

19. The computer-readable storage medium of claim 17, wherein the second dashboard panel view and the first content immersion viewer pane are each independently scrollable.

20. The computer-readable storage medium of claim 17, wherein the method further comprises:
in response to receiving a second selection of a second content card of the plurality of content cards in the second dashboard panel view:
continuing to display the second dashboard panel view with the second scrollable arrangement of the plurality of content cards; and
displaying additional content of a respective content item associated with the second selected content card in a second content immersion viewer pane on the base graphical canvas with the second dashboard panel view.
